(19) United States
(12) Patent Application Publication
(10) Pub. No.: US 2021/0060522 A1
(43) Pub. Date: Mar. 4, 2021

(54) GRAPHENE-BASED MATERIALS FOR THE EFFICIENT REMOVAL OF POLLUTANTS FROM WATER

(71) Applicant: VIRGINIA COMMONWEALTH UNIVERSITY, Richmond, VA (US)

(72) Inventors: M. Samy EL-SHALL, Richmond, VA (US); Fathi Sami MOHAMED AWAD, Richmond, VA (US)

(21) Appl. No.: 16/960,217

(22) PCT Filed: Jan. 8, 2019
(86) PCT No.: PCT/US2019/012653

§ 371 Date: Jul. 6, 2020

Related U.S. Application Data
(60) Provisional application No. 62/614,540, filed on Jan. 8, 2018.

(51) Int. Cl. B01J 20/20; B01J 20/30; C02F 1/28

(52) U.S. Cl. CPC B01J 20/205; B01J 20/3085; C02F 2101/103; C02F 1/281; C02F 1/288

(57) ABSTRACT

Materials and methods for removing contaminants from liquids such as water are provided. The materials are graphene oxide-based materials that are chemically modified to comprise functional groups that adsorb a wide variety of pollutants such as heavy metals, nitrates, and phosphates.

### STATEMENT OF FEDERALLY SPONSORED RESEARCH AND DEVELOPMENT

This invention was made with government support under contract number CHE-1463989 awarded by the National Science Foundation. The United States government has certain rights in the invention.

### BACKGROUND OF THE INVENTION

### Field of the Invention

The invention generally relates to improved materials and methods for removing contaminants, e.g. from liquids such as water. In particular, the invention provides graphene-based materials with high capacities to adsorb pollutants (e.g. heavy metals, nitrates, phosphates, etc.), methods for making the materials and methods for their use to remove contaminants.

### Description of Related Art

Water contamination by pollutants such as heavy metals, nitrogen and phosphates, causes many public health and environmental concerns. Metal ions such as Hg(II), Cu(II), Pb(II), As(V), and Cr(VI), have high toxicity and are not biodegradable. The accumulation of these heavy metals in the human body can lead to several severe and chronic disorders such as impairment of pulmonary function, renal damage, emphysema, hemoptysis, hyper-tension, chest pain, skeletal malformation in fetuses, tremors, and impaired cognitive skills. Thus, there is a critical need to extract these toxic metal ions from polluted and wastewater.

Various processes and techniques have been developed for the extraction of heavy metals such as chemical precipitation, coagulation, flotation, reverse osmosis, electrochemical methods, membrane filtration, ion exchange, irradiation, and adsorption. Adsorption by chelating resins has proven to be the most effective method. Several types of materials such as zeolites, clay, mesoporous carbon, polymers, metal-organic frameworks (MOFs), and covalent organic frameworks (COFs) have been utilized for this purpose. However, most of these materials exhibit low efficiency or complicated post synthesis modifications with long processing times and prohibitive costs, making their practical use for wastewater treatment unfeasible.

In particular, arsenic is a toxic heavy metal which contributes to groundwater contamination by leaching from natural sources and from industrial and chemical waste. Arsenic is a strong carcinogen and exposure can cause skin, lung, urinary bladder, liver and kidney cancers. The World Health Organization (WHO) classifies arsenic as one of the most toxic and carcinogenic chemical elements and recommends that the permissive arsenic standard in drinking water not to exceed 10 ppb. Arsenic exists in the environment in different oxidation states and forms various species containing ions such as As(V), As(III), As(0) and As(-III). Arsenic removal techniques rely on converting arsenic species into other forms or attaching them to insoluble compounds. Adsorption by e.g. iron oxide-based magnetic nanoparticles (e.g. magnetite) is considered to be the simplest, most efficient, most versatile, and economically viable method. However, these adsorbents are difficult to use in continuous flow systems due to their small particle size and instability (magnetite is highly susceptible to oxidation). Furthermore, although some of these materials exhibit high arsenic removal efficiency from water, they lead to significant leaching of iron ions into the water, thus creating another problem for water purification. Graphene-based materials have been evaluated to remove arsenic from contaminated water using adsorption processes. However, most of those materials are prepared by chemical methods which involve the use of hazardous and sometimes toxic chemicals such as hydrazine hydrate. Graphene-based materials made by these methods suffer from residual contamination by the reducing agents, necessitating the use of multiple solvents and several post synthesis treatments such as drying and thermal annealing.

Phosphate and nitrate pollution impacts many bodies of water and results in serious environmental and human health issues. Excess phosphorus and nitrate cause eutrophication (e.g. algal blooms), a dense growth of plant life, which uses all available oxygen and subsequent death of animal life from lack of oxygen. Some algal blooms are also directly harmful to humans because they produce elevated toxins and bacterial growth that cause disease upon contact or consumption of tainted fish, shellfish, or water. Phosphate removal is currently achieved largely by chemical precipitation, which is expensive and causes an increase of sludge volume by up to 40% due to the necessity of adding chemicals to the water in order to precipitate the phosphate. Further, these techniques are useful only in water treatment plants and are not readily adapted for use e.g. in the home or in water sources such as lakes or streams. There is a pressing need to develop new materials and techniques for removing phosphates from water.

There is a pressing need to develop more cost-effective, efficient and environmentally friendly materials for the extraction of pollutants from wastewater. A key challenge is the design of high surface area adsorbents with accessible high affinity binding sites for capturing and retaining pollutants.

### SUMMARY OF THE INVENTION

Other features and advantages of the present invention will be set forth in the description of invention that follows, and in part will be apparent from the description or may be learned by practice of the invention. The invention will be realized and attained by the compositions and methods particularly pointed out in the written description and claims hereof.

Materials and methods for removing contaminants from liquids such as water are disclosed herein. The materials are graphene-based materials (in particular, graphene oxide based materials) that are chemically modified so as to comprise functional groups which adsorb a variety of pollutants (e.g. heavy metals, nitrates, phosphates, etc.). This disclosure discusses how to make, characterize and use the materials.

It is an object of this disclosure to provide a nanocomposite, 2-Imino-4-Thiobiuret Partially Reduced Graphene Oxide (IT-PRGO).

A further object of this disclosure is to provide a method of making 2-Imino-4-Thiobiuret Partially Reduced Graphene Oxide (IT-PRGO), comprising activating carboxylic groups of graphene oxide (GO), combining, in the presence of a catalyst, GO having activated carboxylic groups and amidinothiourea, wherein the step of combining is performed under conditions sufficient to cause a nucleophilic substitution reaction between the activated carboxylic groups of the GO and the amidinothiourea, and recovering IT-PRGO. In some aspects, the method further includes a step of increasing the COOH-group content of the GO prior to the step of activating. In additional aspects, the step of increasing is performed by reacting the GO with Cl—CH₂COOH under basic conditions. In other aspects, the step of activating is performed by reacting the GO with SOCL₂ to form acyl-chloride GO. In further aspects, the catalyst is tetra butyl ammonium bromide.

Also provided is a method of removing heavy metal ions from contaminated water, comprising contacting the contaminated water with IT-PRGO for a period of time and under conditions sufficient to permit adsorption of the heavy metal ions by the IT-PRGO. In some aspects, the heavy metal ions are mercury (Hg) ions, lead (Pb) ions, cadmium (Cd) ions, chromium (Cr) ions, zinc (Zn) ions, Arsenic (As) ions, nickel (Ni) ions or copper (Cu) ions. In other aspects, the conditions sufficient to permit adsorption of the heavy metal ions by the IT-PRGO include performing the step of contacting at a pH of 5.0-5.5. In additional aspects, the method comprises the steps of desorbing the heavy metal ions from the IT-PRGO and repeating the step of contacting, wherein the steps of desorbing and repeating are performed a plurality of times.

Also provided is a method of removing phosphate ions and/or nitrate ions from contaminated water, comprising contacting the contaminated water with IT-PRGO for a period of time and under conditions sufficient to permit adsorption of the phosphate ions and/or the nitrate ions by the IT-PRGO. In some aspects, the method further comprises the steps of desorbing the phosphate ions and/or the nitrate ions from the IP-PRGO and repeating the step of contacting, wherein the steps of desorbing and repeating are performed a plurality of times.

Also provided is a method of removing mercury ions from contaminated water, comprising contacting the contaminated water with acetic acid functionalized improved graphene oxide (IGO-COOH) or with imino-diacetic acid functionalized improved graphene oxide (Imino-IGO) for a period of time and under conditions sufficient to permit adsorption of the mercury ions by the IGO-COOH or the Imino-IGO. In some aspects, the conditions sufficient to permit adsorption of the mercury ions include performing the step of contacting at a pH of 5.0-5.5. In additional aspects, the method comprises the steps of desorbing the mercury ions from the IGO-COOH or the Imino-IGO and repeating the step of contacting, wherein the steps of desorbing and repeating are performed a plurality of times.

Also provided is a nanocomposite, Fe₃O₄-PRGO, comprising partially reduced graphene oxide (PRGO) and a plurality of Fe₃O₄ functional groups immobilized on the PRGO.

Also provided is a method of making partially reduced graphene oxide (PRGO) comprising a plurality of Fe₃O₄ functional groups (Fe₃O₄/PRGO), comprising combining dry, solventless PRGO and dry, solventless Fe₃O₄ nanoparticles; and exposing the dry, solventless PRGO and dry, solventless Fe₃O₄ nanoparticles to a series of laser pulses sufficient to vaporize and ionize the Fe₃O₄ nanoparticles, wherein the step of exposing is performed under an O₂—He mixture. In some aspects, the O₂-He mixture is a 20% O₂ in He mixture. In other aspects, the step of exposing is performed at 800-1000 Ton of pressure. In additional aspects, the series of laser pulses are preformed using λ=400-800 nm pulses, a pulse width of τ=5-20 ns, a repetition rate of 10-100 Hz, and an energy of about 30-100 mJ/pulse. In yet further aspects, the series of laser pulses are preformed using λ=532 nm pulses, a pulse width of τ=7 ns, a repetition rate of 30 Hz, and an energy of 40-60 mJ/pulse. In other aspects, each laser pulse releases at least 10¹⁴ Fe ions into the gas phase.

Also provided is a method of removing phosphate ions and/or nitrate ions from contaminated water, comprising contacting the contaminated water with Fe₃O₄/PRGO for a period of time and under conditions sufficient to permit adsorption of the phosphate ions and/or the nitrate ions by the Fe₃O₄/PRGO. In some aspects, the method further comprises a step of magnetically removing the Fe₃O₄/PRGO from the contaminated water after the period of time.

### BRIEF DESCRIPTION OF THE DRAWINGS

FIG. 1. General procedure for the preparation of 2-Imino-4-Thiobiuret Partially Reduced Graphene Oxide (IT-PRGO).

FIG. 2A-D. SEM (A, B) and TEM images (C, D) of GO (A and C) and IT-PRGO (B and D).

FIG. 3. Two possible pathways for the nucleophilic substitution reactions between 2-imino-4-thiobiuret (amidinothiourea) and acyl chloride functionalized graphene oxide (GO-Cl).

FIGS. 4A and B. (A) Dependence of the IT-PRGO adsorption capacity of Hg(II), Pb(II), Cr(VI), Cu(II), and As(V) ions on the pH of the solution [Conditions: Cₒ=500 mg/L (Hg(II)), 50 mg/L Pb(II), 50 mg/L Cr(VI), 50 mg/L Cu(II), 25 mg/L (As(V); T=273 K; Adsorbent dose=0.005 g/5 ml]. (B) Effect of initial concentration on the removal of Hg(II), Pb(II), Cr(VI), Cu(II), and As(V) on IT-PRGO [Conditions: Cₒ=25-1100 mg/L Hg(II), 10-500 mg/L Pb(II), 10-300 mg/L Cr(VI), 10-250 mg/L Cu(II), 5-150 mg/L As(V); pH=5 Hg(II), 5.5 Pb(II) and Cu(II), 3 Cr(VI), 2.5 As(V); T=273 K; Adsorbent dose=0.005 g/5 ml].

FIG. 5A-C. Dependence of the % removal of metal ions on the contact time for (A) Hg(II) 50 ppm; (B) Pb(II) 25 ppm; (C). Effect of contact time on the removal of Hg(II), Pb(II), Cr(VI), Cu(II), and As(V)) on IT-PRGO [Conditions: Cₒ=1000 mg/L Hg(II), 500 mg/L Pb(II), 250 mg/L Cr(VI), 250 mg/L Cu(II), 150 mg/L As(V); pH=5 Hg(II), 5.5 Pb(II) and Cu(II), 3 Cr(VI), 2.5 As(V); Adsorbent dose=0.005 g/5 ml; T=273 K).

FIG. 6A-C. (A), Effect of adsorbent dose on the removal of Hg(II), Pb(II), Cr(VI), Cu(II), and As(V) on IT-PRGO) (Conditions: Cₒ=1000 mg/L Hg(II), 500 mg/L Pb(II), 250 mg/L Cr(VI), 250 mg/L Cu(II), 150 mg/L As(V); pH=5 for Hg(II), 5.5 for Pb(II) and Cu(II), 3 for Cr(VI), and 2.5 for As(V); T=273 K; Adsorbent dose=1-3.5 g/L). (B), Langmuir isotherm model for the adsorption of Hg(II), Pb(II), Cr(VI), Cu(II), and As(V) ions on IT-PRGO. (C), Pseudo second-order kinetic model for the adsorption Hg(II), Cu(II), Pb(II), Cr(VI) and As(V) ions on IT-PRGO.

FIG. 7. Suggested structures of chelating compounds of Hg(II) ions with IT-PRGO.

FIGS. 8A and B. (A) Metal ions removal on IT-PRGO from a six mixed metal ions solution (C₀=10 mg/L, adsorbent dose=1 g/L, pH=5.0, T=298 K,). (B) (C₀=250 mg/L, pH=5.0, adsorbent dose=1 g/L, T=298 K).

FIG. 9. General procedure for the preparation of imino-diacetic acid improved graphene oxide (imino-IGO).

FIG. 10. Proposed mechanism for the removal of Hg(II) by complexation with the carboxylic groups in the imino-diacetic acid IGO surface.

FIG. 11A-C. (A) Effect of pH of the solution on the removal of Hg(II) ions by the IGO, IGO-COOH, and Imino-IGO adsorbents (Conditions: Cₒ Hg(II)=50 mg/L, T=273 K, Adsorbent dose=0.01 g/10 mL, t=120 min). (B) Effect of initial concentration of Hg(II) ions on their removal by the IGO, IGO-COOH and Imino-IGO adsorbents. (Conditions: Cₒ Hg(II)=10-600 mg/L, T=273 K, pH=5, Adsorbent dose=0.01 g/10 mL, t=120 min). (C) Removal of Hg(II) ions by the IGO, IGO-COOH and Imino-IGO adsorbents (Conditions: Cₒ=10 mg/L, T=273 K, pH 5, Adsorbent dose=0.01 g/10 ml, t=60 min (IGO, IGO-COOH), 120 min (Imino-IGO)).

FIGS. 12A and B. (A) Effect of contact time on the removal of Hg (II) ions on IGO, IGO-COOH, and Imino-IGO. (Conditions: T=273 K, pH=5, Adsorbent dose=0.01 g/10 ml). (B) Effect of adsorbent dose on the removal of Hg(II) ions by the IGO, IGO-COOH and Imino-IGO adsorbents. (Conditions: T=273 K, pH=5, Adsorbent dose=0.01-0.035 g/10 ml, t=120 min).

FIG. 13A-C. Effect of temperature on the removal of Hg(II) ions by the(A) IGO, (B) IGO-COOH, and (C) Imino-IGO adsorbents. (Conditions: Cₒ=10-600 mg/L, pH=5, Adsorbent dose=0.01 g/10 ml).

FIG. 14. Recycling of Imino-IGO for Hg(II) (desorption condition: 0.01 M EDTA), adsorption condition: pH 5, initial concentration of Hg(II) 300 mg/L, dose: 1 g/L).

FIG. 15. Schematic illustrating the Laser Vaporization-Controlled Condensation (LVCC) method used for preparation of Fe and Fe₃O₄ nanoparticles, PRGO nanosheets, and Fe₃O₄/PRGO nanocomposites.

FIGS. 16A and B. X-ray diffraction patterns (A) and (B) for the Fe and Fe₃O₄ nanoparticles, PRGO nanosheets, and Fe₃O₄/PRGO nanocomposite prepared using the LVCC method.

FIGS. 17A and B. (A) UV-Vis and (B) Raman spectra for the PRGO samples prepared respectively in He and in 20% O₂ and the Fe₃O₄/PRGO nanocomposite prepared in 20% O₂ using the LVCC method.

FIG. 18A-C. TEM images (A) PRGO nanosheets, (B) Fe₃O₄ nanoparticles, and the (C) Fe₃O₄-PRGO nanocomposite prepared in 20% O₂ using the LVCC method.

FIGS. 19A and B. (A) XPS spectra for the C 1 s electron for Graphite Oxide (GO), PRGO prepared in both He and 20% O₂, and Fe₃O₄/RGO prepared in 20% O₂ by the LVCC method. (B) XPS spectra for the Fe 2p electron for the Fe—He, Fe₃O₄-20% O₂, and Fe₃O₄/RGO-20% O₂ samples prepared by the LVCC method.

FIGS. 20A and B. (A) Effect of initial concentration on the removal of As(V) on PRGO, Fe₃O₄, and Fe₃O₄/PRGO composite. (B) The percentage of removal of As(V) on PRGO, Fe₃O₄, and Fe₃O₄/PRGO. (Conditions: (Cₒ=0.1-500 mg/L, T=273 K, Time=2 h, Adsorbent dose=0.005 g/5 ml, pH=4).

FIGS. 21A and B. Effect of contact time on the removal efficiency of As(V) on PRGO, Fe₃O₄ nanoparticles and Fe₃O₄/PRGO nanocomposite (A) at initial concentration of As(V) 50 mg·L⁻¹ and (B) at initial concentration of As(V) 300 mg·L⁻¹. (Conditions: (Cₒ=50 mg/L, T=273 K, Adsorbent dose=0.005 g/5 ml, pH=4.

FIGS. 22A and B. Effect of interfering ions on the removal of As⁵⁺ on (A) Fe₃O₄, (B) Fe₃O₄/PRGO composite. (Conditions: (C_{o As5+}=100 mg/L, C_{o interfering anions}=100 mg/L, T=273 K, Adsorbent dose=0.005 g/5 ml, pH=6, T=2 h).

FIG. 23. Recycling of Fe₃O₄/PRGO composite for As(V) (desorption condition: 0.07 M NaOH), adsorption condition: pH 6, dose: 1 g/L, initial concentration of As(V) 50 mg/L).

### DETAILED DESCRIPTION

The present disclosure describes graphene-based nanomaterials that comprise graphene oxide modified with functional groups which render the materials capable of adsorbing a variety of ionic species. In some aspects, the functional groups are chelating agents capable of binding e.g. one or more of metal ions, phosphate ions and nitrate ions. The materials include 2-imino-4-thiobiuret partially reduced graphene oxide (IT-PRGO), acetic acid functionalized IGO (IGO-COOH), imino-diacetic acid functionalized IGO (Imino-IGO), and Fe₃O₄-PRGO.

The graphene-based materials are capable of adsorbing a variety of contaminants that frequently pollute water, for example, heavy metals, phosphates and nitrates. Upon exposure of the graphene-based materials to contaminated water, the contaminants bind strongly to the graphene-based materials (e.g. to the functional groups immobilized on the nanomaterials) and are thus sequestered and removed from the water upon separation of the graphene-based materials from the water. The graphene-based materials are advantageously recyclable, e.g. after they have adsorbed contaminants, the contaminants can be stripped (desorbed) from the materials and the materials can be used again for further rounds of adsorption. In some aspects, the contaminants are also advantageously recovered for various uses.

### Definitions

Chelation is a type of bonding of ions and molecules to metal ions. It involves the formation or presence of two or more separate coordinate bonds between a polydentate (multiple bonded) ligand and a single central atom. These ligands are called chelants, chelators, chelating agents, or sequestering agents. They may be organic compounds.

Graphene is an allotrope (form) of carbon consisting of a single layer of carbon atoms arranged in a hexagonal lattice. It is a semimetal with small overlap between the valence and the conduction bands (zero bandgap material).

The graphene-based materials are generally nanomaterials (e.g. nanocomposites, nanosheets, nanoparticles, etc.) comprised of graphene oxide (GO) or “improved graphene oxide” (IGO) with functional groups, such as chelating groups, immobilized thereon. “Nanomaterials” include materials of which a single unit is sized (in at least one dimension) between 1 to 1000 nanometres (10⁻⁹ meter) such as from about 1 to 100 nm.

As used herein, “GO” refers to graphene oxide produced by the conventional Hummers' method (Hummers Jr, W. S.; Offeman, R. E., Journal of the American Chemical Society 1958, 80 (6), 1339-1339). “Improved graphene oxide” (IGO) refers to graphene oxide synthesized by the method described by Marcano, et al. in ACS Nano 2010, 4 (8), 4806-4814 and in US patent application 20120129736, the entire contents of which are herein incorporated by reference in entirety. The materials described herein as made with “GO” can also be made using “IGO” as the starting material, and vice versa, i.e. “GO” can be substituted for “IGO”.

As is known in the art, GO or IGO is graphene comprising a plurality of OH, COOH and epoxide functional groups. In some aspects, the GO or IGO is partially reduced (PRGO, PR-IGO). “Partially reduced GO or IGO” refers to GO or IGO in which at least a portion of the OH, COOH or epoxide functional groups have been reduced. Partially reduced GO/IGO generally also has chemical and structural “defects” (such as holes, edges, sp3 hybridization of the carbon atoms, missing carbon atoms, etc.) which can be advantageous for some purposes.

2-imino-4-thiobiuret Partially Reduced Graphene Oxide (IT-PRGO)

In some aspects, the graphene-based material is the novel material 2-imino-4-thiobiuret partially reduced graphene oxide (IT-PRGO). This material is prepared by activating carboxylic groups of graphene oxide (GO) and combining the GO having the activated carboxylic groups with amidinothiourea. The step of combining occurs under conditions which permit or foster a nucleophilic substitution reaction between the activated carboxylic groups and the amidinothiourea, to form IT-PRGO. Generally, the step of combining is performed in the presence of a catalyst. A step of recovering the synthesized IT-PRGO may also be included.

GO and IGO as synthesized generally contain a plurality of COOH groups. However, for the present purposes, in some aspects, the COOH-group content of the GO is (optionally) further increased prior to the step of activating. This step is generally performed in a liquid medium under basic conditions, e.g. in deionized water at a pH in the range of from about 8 to about 10, such as about 9 (e.g. about 8, 8.5, 9.0, 9.5 or 10) for a period of time ranging from about 1 to about 5 hours, such as about 1, 2, 3, 4, or 5 hours; and within a temperature range of from about 20 to about 25° C., e.g. 20, 21, 22, 23, 24, or 25° C., such as at room temperature. The reaction is generally performed with some form of agitation, e.g. sonication, etc. Following this, the reaction mixture is acidified using an acid such as HNO₃ or HCl, etc., the product, GO-COOH is separated (e.g. by centrifugation, filtration, etc.) and dried prior to further processing. Drying may be accomplished is any of several ways, e.g. in an oven at about 50-90° C. (about 50, 60, 70, 80 or 90° C.) for about 6-24 hours, such as for about 6, 12, 18 or 24 hours, or longer as needed to achieve a dry product.

Agents that are used to increase the COOH-group content include but are not limited to: Cl—CH₂COOH, Br—CH₂COOH or I—CH₂COOH. In some aspects, the agent is Cl—CH₂COOH.

Agents which are used to activate carboxylate groups which are present on the GO include but are not limited to: agents which transfer a halogen (e.g. Cl, Br, etc.) to the acyl group such as SOCl₂, SOBr₂, etc. Depending on the agent that is used, the corresponding reactive acyl-halide is formed.

The step of combining the GO having the activated carboxylic groups with amidinothiourea is generally performed in the presence of a catalyst. Examples of catalysts that are employed include but are not limited to: tetra butyl ammonium bromide, tetra butyl ammonium iodide, etc.

The IT-PRGO that is made as described herein may be used for any purpose. In some aspects, the IT-PRGO is used to remove heavy metal ions e.g. from a contaminated liquid such as contaminated water. Such methods comprise contacting the contaminated water with IT-PRGO for a period of time and under conditions sufficient to permit adsorption of the heavy metals by the IT-PRGO. Adsorption is generally performed under ambient conditions, e.g. at or near about 25° C.

The conditions sufficient to permit adsorption of the heavy metals such as Hg(II), Cu(II) and Pb(II) by the IT-PRGO may include performing the step of contacting at a pH in the range of from about 4.0 to about 6.5, e.g. at a pH of about 4.0, 4.2, 4.3, 4.4, 4.5, 4.6, 4.7, 4.8, 4.9, 5.0, 5.1, 5.2, 5.3, 5.4 or 5.5. In some aspects, the pH range is about 5.0-5.5.

For As(V) and Cr(VI), the maximum adsorption occurs at lower pH values (e.g. 1-3). However, more moderate pH conditions may be used since adequate adsorption of those metals may occur at higher pH values, if exposure to the contaminated liquid is prolonged.

The time required for adsorption can be varied as needed to achieve a beneficial level of metal ion removal, and may range from minutes (e.g. about 5-60 minutes such as about 5, 10, 20, 30, 40, 50 or 60 minutes), to hours (e.g. about 2-24 hours such as about 2, 4, 6, 8, 10, 12, 14, 16, 18, 20, 22 or 24 hours) or even days (e.g. about 1-7 days such as 1, 2, 3, 4, 5, 6, or 7 days).

Heavy metal (and other) ions that may be sequestered using IT-PRGO include but are not limited to mercury (Hg) ions, lead (Pb) ions, cadmium (Cd) ions, chromium (Cr) ions, zinc (Zn) ions, Arsenic (As) ions, nickel (Ni) ions, copper (Cu) ions, phosphate, nitrate, etc.

The IT-PRGO is advantageously recyclable. To recycle and reuse the material, the sequestered or adsorbed metal ions are desorbed from the IT-PRGO, generally by exposure to (washing with) an acidic solution which may comprise one or more metal chelating agents (e.g. EDTA, EGTA, etc.) and/or other agents (such as reducing agents).

Desorbing solutions may differ from metal to metal. For example, to desorb Hg(II), a solution of an acid such as HNO₃ (e.g. about 0.5 to 5 M, such as about 0.5, 1.0, 1.5, 2.0, 2.5, 3.0, 3.5, 4.0, 4.5 or 5.0%) may be used, usually in combination with a reducing agent such as thiourea (e.g. about 1-10%, such as 1, 2, 3, 4, 5, 6, 7, 8, 9 or 10%). In some aspects, the desorbing solution is 2M HNO₃ and 6% thiourea. Other options for desorbing Hg(II) include but are not limited to: EDTA (ethylene diamine tetra acetic acid).

In some aspects, for desorbing Pb(II) or Cu(II), an acidic solution such as HNO₃ is used e.g. from about 0.1 to about 2.0 M HNO₃ such as about 0.5, 0.5, 1.0, 1.5 or 2.0 M. Such a solution may or may not comprise additional agents such as chelating agents, reducing agents, etc.

In some aspects, for desorbing Cr(VI), a basic solution is used, e.g. a solution of about 0.1 to about 2M NaOH or other suitable base such as KOH. The concentration of base is, for example, about 0.1, 0.5, 1.0, 1.5 or 2.0 M. Such a solution may or may not comprise additional agents such as chelating agents, reducing agents, etc.

For IT-PRGO, desorption is generally performed for a period of time ranging from about 30 min to about 7 hours, (e.g. about 1, 2, 3, 4, 5, 6, or 7 hours) and is generally about two hours. Desorption may be performed at any convenient temperature, and is usually done at about room temperature (e.g. about 20-25° C., such as about 23° C.). However, higher temperatures may be used to speed the process, such as up to about 70° C. (such as about 30, 40, 50 60 or 70° C.).

After removal of the metal ions, the IT-PRGO is washed with a suitable solvent (e.g. a solvent with a pH in the range that is suitable for adsorbing metal ions) and steps of contacting contaminated water with IT-PRGO as described above are repeated. This procedure may be performed many times before the IT-PRGO loses the ability to adsorb metal ions, e.g. up to about 10 or more times, such as 2, 3, 4, 5, 6, 7, 8, 9 or 10 times.

Metal ions that are desorbed from the IT-PRGO may be recovered and disposed of in an environmentally appropriate manner, or may be recovered and further processed for use, e.g. in manufacturing.

### IGO, Acetic Acid Functionalized IGO (IGO-COOH) and Imino-Diacetic Acid Functionalized IGO (Imino-IGO)

Also provided herein are nanocomposites that are i) acetic acid functionalized IGO (IGO-COOH) and imino-diacetic acid functionalized IGO (Imino-IGO), and methods for making these materials. They are described together in this disclosure because some steps for their production may overlap. IGO is the starting material for both and may also be used to sequester contaminants such as metal ions.

### IGO

IGO is generally prepared according to the method described in Marcano, et al. A 9:1 mixture of concentrated H₂SO₄/H₃PO₄ (540:60mL) was added to a mixture of graphite flakes (4.5 g) and KMnO₄ (27.0 g) and maintained below 30° C. using an ice bath. The reaction was then heated to 50° C. and stirred for 12 hours. The reaction was cooled to room temperature and poured onto ice (600 mL) containing 30% H₂O₂ (4.5 mL). The mixture was then centrifuged and the remaining solid material was washed in succession with 200 mL of water, 200 mL of 30% HNO₃, and 200 mL of 2% ethanol. The IGO is then dried as described elsewhere herein for other compounds.

### IGO-COOH

IGO-COOH is generally prepared from IGO dispersed in suitable solvent such as deionized water e.g. for about 30 minutes to 2 hours (such as for 1 hour) until the solution is clear. An acyl transfer agent such as Cl—CH₂COOH is added under basic conditions (e.g. a pH of about 8-9, e.g. about 8.0, 8.5 or 9) followed by agitation e.g. via stirring, sonication, etc. for about 1-5 hours, e.g. about 1, 2, 3, 4 or 5 hours. The pH of the mixture is then adjusted to 6.5 using an acid such as HNO₃, HCl, etc. and the product is separated from the reaction mixture, e.g. by filtration, centrifuged, or another technique. The separated product is then washed e.g. with DI water, several times and dried. Drying may be performed at an elevated temperature with or without a vacuum.

### Imino-IGO

The preparation of Imino-IGO involves several steps. The Imino-IGO is prepared from IGO-COOH by first converting the IGO-COOH to acyl-chloride functionalized IGO (IGO-Cl). To do so, in an exemplary method, IGO-COOH is dispersed in an anhydrous solvent (such as DMF or other known anhydrous solvents) followed by thorough mixing (e.g. sonication for 1 hour) and then treatment with a chlorinating agent. In some aspects, SOCl₂ is used as the chlorinating agent; however, other chlorinating agents are known in the art and may also be employed. The chlorination reaction is generally performed at an elevated temperature e.g. at about 60 to 95° C., such as at about 60, 65, 70, 75, 80, 85, 90, or 95° C., and is performed for a period of time ranging from about 1-5 days, e.g. about 1, 2, 3, 4, or 5 days. The product is then separated (e.g. by filtration, centrifugation, etc.), washed with anhydrous solvent (e.g. DMF) and dried Drying may be performed at an elevated temperature with or without a vacuum.

Next, the IGO-Cl is converted to ethylene diamine functionalized IGO (IGO-NH₂). Generally, IGO-Cl is dispersed in an anhydrous solvent such as DMF or others listed above, in the presence of an alkyl diamine (e.g. ethylene diamine, triethyl amine, etc.) and a suitable base/buffering agent (e.g. Et₃N). The mixture is reacted (e.g. refluxed) at a temperature ranging from about 60 to about 100° C., e.g. about 60, 70, 80, 90 or 100° C. for several hours, such as at least about 12, 24, 36 or 48 hours or longer. Thereafter, the solution is cooled (e.g. to room temperature) and the product is separated, e.g. by filtration, centrifugation, etc., and washed with e.g. ethanol/DI water, followed by drying as described above for other graphene-based compound.

The final step of making Imino-IGO is performed by dispersing IGO-NH₂ in a buffer at pH about 9.0 to 10.5, such as 0.0, 9.5, 10.0 or 10.5). Examples of buffers that can be used include but are not limited to carbonate buffer. An acyl transfer agent such as ClCH₂COOH is added and the mixture is allowed to react for e.g. about 5 to 30 minutes, such as about 5, 10, 15, 20, 25 or 30 minutes, with agitation e.g. sonication, etc. to insure proper mixing. The pH is maintained at e.g. pH=9.5-10.0. The mixture is reacted (e.g. refluxed) for about 5 to 15 hours, such as about 5, 10 or 15 hours, at an elevated temperature, such as about 50 to 90° C. (e.g. about 50, 60, 70, 80 or 90° C.). The product is separated and dried as described above for other compounds.

One or more of IGO and/or the IGO-COOH and/or the Imino-IGO is used to remove metal ions from water, especially heavy metal ions such as mercury, lead, copper, cobalt, nickel or zinc. The methods comprise contacting the contaminated water with the IGO, IGO-COOH or Imino-IGO for a period of time and under conditions sufficient to permit adsorption of the metal ions (e.g. mercury ions) by the IGO, IGO-COOH or Imino-IGO. Conditions sufficient to permit adsorption of the ions include, for example, performing the step of contacting at a pH of about 4.0 to about 6.5, e.g. at a pH of about 4.0, 4.2, 4.3, 4.4, 4.5, 4.6, 4.7, 4.8, 4.9, 5.0, 5.1, 5.2, 5.3, 5.4 or 5.5. In some aspects, the pH range is about 5.0-5.5. Adsorption is generally performed at ambient temperature.

The time required for adsorption can be varied as needed to achieve a beneficial level of metal ion removal, and may range from minutes (e.g. about 5-60 minutes such as about 5, 10, 20, 30, 40, 50 or 60 minutes), to hours (e.g. about 2-24 hours such as about 2, 4, 6, 8, 10, 12, 14, 16, 18, 20, 22 or 24 hours) or even days (e.g. about 1-7 days such as 1, 2, 3, 4, 5, 6, or 7 days).

The IGO, IGO-COOH and the Imino-IGO are advantageously recyclable. To recycle and reuse these materials, the sequestered or adsorbed metal ions are generally desorbed by washing with e.g. an acidic solution such as about 0.1 to about 2 M HCl, e.g. about 0.1, 0.5, 1.0, 1.5 or 2.0 HCl. In some aspects, 1.0 M HCl is used. Alternative methods include desorption using a chelating agent. For example, a solution of EDTA in the range of from about 0.005 to about 0.1 may be used, e.g. 0.005, 0.075 or 0.01, 0.02, or 0.03 M or more may be used.

Desorption is generally performed for a period of time ranging from about 30 min to about 7-8 hours (e.g. about 1, 2, 3, 4, 5, 6, 7, or 8 hours) and is generally about 2-3 hours. Desorption may be performed at any convenient temperature, and is usually done at about room temperature (e.g. about 20-25° C., such as about 23° C.). However, higher temperatures may be used to speed the process, such as up to about 60-75°, e.g. about 30, 35, 40, 45, 50, 55, 60, 65, 70 or 75° C.

Thereafter, the IGO, IGO-COOH or Imino-IGO is washed with a suitable solvent (e.g. a solvent with a pH in the range that is suitable for adsorbing metal ions) and steps of contacting contaminated water with IGO, IGO-COOH and/or Imino-IGO as described can then be repeated. This procedure may be performed many times before the materials lose the ability to adsorb metal ions, e.g. up to about 10 or more times, such as 2, 3, 4, 5, 6, 7, 8, 9 or 10 times.

Metal ions (e.g. mercury) that are desorbed from the IGO-COON and the Imino-IGO may be recovered and disposed of in an environmentally appropriate manner, or may be recovered and further processed for use, e.g. in manufacturing.

Fe₃O₄-PRGO

Also encompassed herein is the novel nanocomposite Fe₃O₄-PRGO. Fe₃O₄-PRGO comprises partially reduced graphene oxide (PRGO) and a plurality of Fe₃O₄ functional groups immobilized on the PRGO. The technique used for production of Fe₃O₄-PRGO is Laser Vaporization Controlled Condensation (LVCC). This method advantageously does not involve the use of any chemical reducing agents or solvents, and results in the formation of highly stable magnetic PRGO nanocomposites, such as the exemplary Fe₃O₄-PRGO nanocomposites.

The production of Fe₃O₄-PRGO generally involves combining (mixing) dry, solventless PRGO and dry, solventless Fe₃O₄ nanoparticles and exposing the dry, solventless mixture to a series of laser pulses sufficient to vaporize and ionize the Fe₃O₄ nanoparticles. Each laser pulse releases at least about 10¹⁴ Fe ions into the gas phase, e.g. about 10¹⁰-10¹⁸ Fe ions or about 10¹⁰, 10¹², 10¹⁴, 10¹⁶, or 10¹⁸ Fe ions are released. Generally, the exposing is performed under a mixture of O₂ in He gas, such as about 10 to 30% O₂, e.g. about 10, 15, 20, 25 or 30% O₂, such as about 20% O₂. It is noted that if the exposure is performed under pure He, then Fe-PRGO is formed. This reaction is typically performed under pressure, such as under about 800, 900 or 1000 Torr of pressure, e.g. about 900 Torr. The series of laser pulses are preformed using e.g. λ=about 400-800 nm pulses (such as 400, 500, 600, 600 or 800 nm pulses), a pulse width of about τ=5-20 ns (such as 5, 10, 15, or 20 ns), a repetition rate of about 10-100 Hz (such as about 10, 20, 30, 40, 50, 60, 70, 80, 90 or 100 Hz), and an energy of about 30-100 mJ/pulse (such as about 30, 40, 50, 60, 70, 80, 90, or 100 mJ/pulse). In some aspects, λ=is about 532 nm pulses, a pulse width of about τ=7 ns, a repetition rate of about 30 Hz, and an energy of about 40-60 mJ/pulse.

Generally, the number of Fe₃O₄ functional groups that are immobilized on the PRGO ranges from about 1 wt % to about 50 wt %, e.g. about 1, 5, 10, 15, 20, 25, 30, 35, 40, 45 or 50 wt %.

The reagent Fe₃O₄-PRGO is particularly well-suited for the removal of ionic negatively charged contaminants (e.g. anions) such as arsenate, phosphate, nitrate, chromate, etc. To do so, exposure to a water source that is to be decontaminated is generally performed at ambient temperatures (e.g. about 25° C.) and the water source is preferably held at a pH of from about 4-6, e.g. a pH of about 4.0, 4.5, 5.0, 5.5 or 6.0. However, if this range is not attainable, adsorption will still occur, albeit at a slower rate.

The time required for adsorption can be varied as needed to achieve a beneficial level of metal ion removal, and may range from minutes (e.g. about 5-60 minutes such as about 5, 10, 20, 30, 40, 50 or 60 minutes), to hours (e.g. about 2-24 hours such as about 2, 4, 6, 8, 10, 12, 14, 16, 18, 20, 22 or 24 hours) or even days (e.g. about 1-7 days such as 1, 2, 3, 4, 5, 6, or 7 days).

Since these nanoparticles are magnetic, they are readily removed from the medium from which they have scavenged contaminants by magnetic attraction.

### Devices Comprising the Materials Described Herein

For use, the materials described herein are generally placed, housed or confined in a device. The devices are typically carriers designed so as to be appropriately sized and dimensioned to suit the intended purpose. For example, to treat industrial effluent or municipal waste water, the graphene-based materials are generally incorporated into very large, industrial-sized porous beds or filters which direct the flow of the water that is to be treated through or over the bed or filter. Residence times and flow rates of the water with the graphene-based materials and the surface area of the graphene-based materials that are exposed to the water are adjusted to permit adequate time and exposure so that adsorption of the metal ions is maximized.

Alternatively, the materials described herein may be mixed directly into a contaminated liquid and then typically mixed and allowed to settle and/or filtered to remove them from the liquid.

The graphene-based materials are also used on smaller scales. For example, the materials may be incorporated into filters used close to a source of water for personal use, e.g. as part of a filtration system for home water treatment, within pipes which supply water to homes and businesses, and/or on even smaller scales such as in e.g. filters for water pitchers or reusable “water bottles”, etc. Any and all such uses as may be envisioned are encompassed herein.

Water from any source and intended for any purpose can be treated by the materials and methods disclosed herein. The sources and types of water include salt water (e.g. from the sea); fresh water (water from lakes, streams, wells, etc.); waste water e.g. industrial effluent such as from mining operations; municipal waste water that is processed at treatment plants, etc.; drinking water; water for manufacturing, especially for manufacturing drugs or comestibles. The materials are also used e.g. in the production of bottled water or any product that comprises water (especially products intended for consumption or skin care, or products for use in laboratories or for the manufacture of medicaments), to insure that the products that are produced are free of contaminants.

In some aspects, dry forms of the reagents may be added to a contaminated liquid, or a liquid in need of sequestration of metal, phosphate and/or nitrate ions, and allowed to mix with the liquid (e.g. with or without agitation or stirring). During mixing, the ions are adsorbed and the nanoparticles are then removed, e. g. by filtration, centrifugation (depending on the volume of the liquid), sedimentation, or, in the case of magnetic agents, by exposure to a source of magnetism which attracts and holds the nanoparticles.

### Other Uses

While the graphene-based materials are advantageously used to remove contaminants from liquids such as water, they may also be used for other purposes. For example, they may be used to facilitate chemical reactions, to remove excess reactants or unwanted materials from chemical mixtures of any type, etc.

It is to be understood that this invention is not limited to particular embodiments described herein above and below, and as such may, of course, vary. It is also to be understood that the terminology used herein is for the purpose of describing particular embodiments only, and is not intended to be limiting.

Where a range of values is provided, it is understood that each intervening value between the upper and lower limit of that range (to a tenth of the unit of the lower limit) is included in the range and encompassed within the invention, unless the context or description clearly dictates otherwise. In addition, smaller ranges between any two values in the range are encompassed, unless the context or description clearly indicates otherwise.

Unless defined otherwise, all technical and scientific terms used herein have the same meaning as commonly understood by one of ordinary skill in the art to which this invention belongs. Representative illustrative methods and materials are herein described; methods and materials similar or equivalent to those described herein can also be used in the practice or testing of the present invention.

All publications and patents cited in this specification are herein incorporated by reference as if each individual publication or patent were specifically and individually indicated to be incorporated by reference, and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual dates of public availability and may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as support for the recitation in the claims of such exclusive terminology as “solely,” “only” and the like in connection with the recitation of claim elements, or use of a “negative” limitations, such as “wherein [a particular feature or element] is absent”, or “except for [a particular feature or element]”, or “wherein [a particular feature or element] is not present (included, etc.) . . . ”.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### EXAMPLES

### Example 1

### 2-Imino-4-Thiobiuret Partially Reduced Graphene Oxide (IT-PRGO) as an Adsorbent for the Effective Extraction of Heavy Metal Ions from Water

This example describes the development of IT-PRGO nanosheets containing the amidinothiourea groups as effective chelating agents for Hg(II) and other toxic metal ions such as Cu(II), Pb(II), Cr(VI) and As(V). Detailed studies of the kinetics of the adsorption isotherms were performed, their facile regeneration was demonstrated.

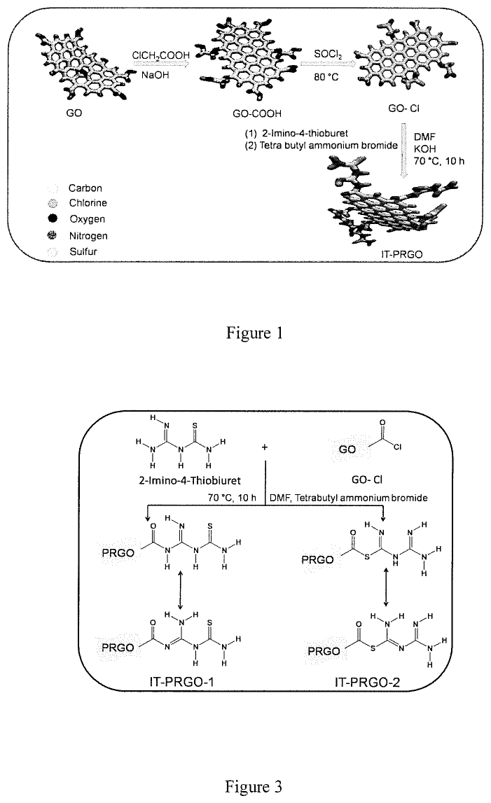

The general procedure for the preparation of IT-PRGO is shown in FIG. 1. The method involves the activation of the carboxylic groups of GO by SOCl₂ followed by a nucleophilic substitution reaction with amidinothiourea in the presence of tetra butyl ammonium bromide as a catalyst. This design strategy results in the formation of IT-PRGO where GO is partially reduced to form PRGO nanosheets containing the strongly chelating AO functional groups.

### 2. Experimental Section

2.1. Materials. All reagents used in this work were analytical grade, used without further purification, and purchased from Sigma Aldrich. Graphite powder (99.999%), Phosphoric acid (99%), Sulfuric acid (99%), Potassium permanganate (99%), Hydrogen peroxide (30%), Thionyl chloride (99%), 2-Imino-4-thiobiuret (99%), and Tetra butyl ammonium bromide (99%). Stock solutions of various concentration of each metal ion prepared from HgCl₂, CuCl₂.2H₂O, Pb(NO₃)₂, K₂Cr₂O₇, KH₂AsO₄, Ni(NO₃)₂.6H₂O, Cd(NO₃)₂ and Zn(NO₃)2.6H₂O were used as sources for the Hg(II), Cu(II), Pb(II), Cr(VI), As(V), Ni(II), Cd(II) and Zn(II) ions, respectively.
2.2. Synthesis of 2-Imino-4-Thiobiuret-Reduced Graphene Oxide (IT-PRGO). GO was prepared by the improved Hummer method (Marcano, et al. ACS Nano 2010, 4 (8), 4806-4814) where a 1: 9 volume mixture of concentrated H₃PO₄:H₂SO₄ (60:540 mL) was used with graphite flakes (4.5 g) and KMnO₄ (27.0 g), and the mixture was maintained below 30° C. using an ice bath. The reaction was then stirred and heated for 12 h at 50° C. The mixture was cooled to room temperature and poured onto ice (600 mL) with 30% H₂O₂ (4.5 mL). The mixture was then centrifuged, and the solid material was washed several times with 200 ml of 30% HNO₃, 200 mL of water, and 200 ml of ethanol (2%). The final product was vacuum dried overnight at 60° C., resulting in 7.5 g of product. To increase the number of carboxylic groups on the graphene oxide surface, 0.5 g of GO was well dispersed in 500 ml DI water for 60 min to give a clear solution. 10 g Cl—CH₂COOH and 12 g NaOH were added to the GO solution and sonicated for 3 h. The suspension was then neutralized to pH 6.5 using HNO₃. The product was separated by centrifugation, washed several times with DI water and dried in oven at 70° C. for 12 h. For the preparation of acyl chloride graphene oxide, 0.5 g of GO-COOH was dispersed well in 10 ml anhydrous N,N-dimethyl-form amide (DMF) by sonication for 1 h and was then treated with thionyl chloride (SOCl₂) (75 mL) at 80° C. for 72 h. The final material was separated by centrifugation, washed with anhydrous DMF and dried under vacuum. For the preparation of IT-PRGO, a suspension of GO-COCl (1 g) in anhydrous DMF (20 mL) was added to a solution of 2-imino-4-thiobiuret (2.3 g) and tetrabutyl-ammonium bromide (0.24 g) in 10 mL of DMF, and the mixture was stirred at 25° C. for 120 min and then refluxed at 70° C. overnight. Finally, the product IT-PRGO was separated using filter paper, washed with distilled ethanol then water and dried for 24 h at 65° C. under vacuum.
2.3. Characterization. The GO and IT-PRGO were characterized by X-ray diffraction using an X'Pert Philips Materials Research Diffractometer, FT-IR spectroscopy using the Nicolet-Nexus 670 FTIR Spectrometer (4 cm⁻¹ resolution and 32 scan), Diamond Attenuated Total Reflectance (DATR), X-ray Photoelectron Spectroscopy (XPS) using the Thermo Fisher ESCAlab 250, SEM using the Hitachi SU-70 FE-SEM, TEM using the Jeol JEM-1230 microscope, and Raman spectroscopy using the Thermo Scientific DXR Smart Raman with 532 nm excitation.
2.4. Extraction of Heavy Metal Ions. The Adsorption of toxic metal ions, e.g. Hg(II), was studied in batch experiments using a series of 20 mL glass vials containing 10 mL of Hg(II) ions solution at the desired pH, initial concentration, and agitation time. Inductively Coupled Plasma Optical Emission (ICP-OES) was used to measure the residual concentration of Hg(II) ions where the samples were acidified with 2% HNO₃ prior to analysis. The amount of mercury adsorbed per unit mass of adsorbent and the percentage of removal were calculated as follows.

$$\begin{matrix}Extraction \% = \frac{( {C}_{0} - {C}_{e} )}{{C}_{0}} \times 100 & ( 1 ) \\ {q}_{e} = \frac{( {C}_{0} - {C}_{e} ) V}{m} & ( 2 )\end{matrix}$$

where Cₑ and Cₒ are the equilibrium and initial and concentration Hg (II) ions (mg/L), respectively, qₑ is the adsorption capacity (mg/g), V is the volume of the solution of Hg (II) ions (L), and m is the mass of adsorbent (g).
2.5. Adsorption kinetics. The time required to reach equilibrium adsorption of each heavy metal ion on the IT-PRGO was determined by measuring the adsorption capacity as a function of time. Adsorption kinetics were conducted by adding 5 mg of adsorbent to 20 mL glass vials containing 5 ml of x mg/L of each toxic metal ion solution at room temperature. The vials were then stirred and the solutions were filtered at different time intervals (5, 15, 30, 45, 60, 90, 120, 180, 240, 360. 420 min) using filter papers. ICP-OES was used to measure the equilibrium concentration of the heavy metals in the supernatant. The amount of metal ions adsorbed onto the IT-PRGO at time t, qₜ (mg/g) was determined using Eq. 2. The effect of adsorbent dose on the extraction of the heavy metal ions Hg(II), Cu(II), Pb(II), Cr(VI), and As(V) was studied using different amounts of IT-PRGO (5, 10, 15, 20, 30, 35 mg) in a 20 ml glass vial containing 5 ml of each heavy metal ion at definite concentration. The effect of pH was determined by adjusting the solution pH (1-8) using a few drops of 0.01 M NaOH and 0.01 M HCl solutions. The batch adsorption studies were conducted under continuous magnetic stirring for 4 h at 25° C. After each adsorption experiment, the IT-PRGO sample was removed and the residual concentrations of the metal ions were determined by ICP-OES.
2.6. Desorption Studies. In these experiments, metal-loaded adsorbent was collected from the suspension by centrifuging, washed with DI water and dried at 60° C. Then, a certain amount of the adsorbent loaded was placed in a series of glass vials containing 10 mL of different eluents (0.2-1.0 M HCl, 0.01 EDTA) and the mixture was agitated at 25° C. for 5 hours. The final concentration of metal ions in the eluent was determined by ICP-OES. The desorption efficiency were then calculated as:

$$Desorption efficiency = \frac{( {C}_{e} - {C}_{0} ) {V}_{e}}{{q}_{e} m} \times 100 \qquad ( 3 )$$

where Cₒ is the initial concentration of heavy metal ions in the eluent (mg/L), Cₑ is the equilibrium concentration (mg/L) after desorption, qₑ is the adsorption capacity in the removal test, Vₑ is the volume of the eluent (L) and m is the mass of the IT-PRGO adsorbent.
2.7. Selectivity Studies. The selectivity of the IT-PRGO towards Hg(II) was investigated by adding 5 mg of the resin to a glass vial containing 5 mL of a mixture of the metal ions Hg(II), Cu(II), Pb(II), Ni(II), Zn(II), Cd(II), and stirred for 4 h and then filtered. The concentration of each metal ion in the filtrate was determined by ICP-OES.

### 3. Results and Discussion

### 3.1. Characterization of IT-PRGO

The UV-Vis spectrum of GO showed two characteristic peaks: a shoulder at 295 nm corresponding to n-π* transitions of C═O, C═S, C—O, C—S, and C—N bonds and a maximum peak around 229 nm, which can be assigned to π-π* transitions of C═C bonds. The disappearance of the 295 nm peak and the red shift of the π-π* transition of the aromatic C═C bond to 278 nm in the spectrum of IT-PRGO indicated the partial reduction of GO and the restoration of some of the C═C bonds in the PRGO sheets.

The XRD patterns of GO and IT-PRGO revealed a sharp peak of GO at 2θ=10.6° indicating an interlayer distance of 0.80 nm due to the presence of oxygen functional groups on the surface of the GO sheets, which lead to larger separation between the layers as compared to graphite. The XRD pattern of IT-PRGO exhibited a weak broad diffraction peak at a small diffraction angle of 5.9°, suggesting an increased interlayer spacing of 1.49 nm due to the chemical grafting of 2-imino-4-thiobiuret onto the GO sheets, which results in larger spacing between the exfoliated layers due to the bulky size of the IT groups. The disappearance of a peak at 2θ=10.6° also provided evidence for the partial reduction of GO. On the other hand, a broad peak at 24.5° with interlayer spacing 0.35 nm may be explained by the restacking of IT-PRGO sheets. It appears that after the removal of water, the majority of the IT-PRGO nanosheets restack, resulting in a diffraction peak at 2θ=24.5° and only a small fraction stays exfoliated showing a diffraction peak at 2θ=5.9°.

Raman spectra of IT-PRGO and GO showed the characteristic peaks (D and G bands) of graphene-based materials. The G band is associated with the stretching vibration of the conjugated C═C groups and it appears at almost the same frequency of 1592 cm⁻¹ in GO and IT-PRGO. The D band is related to the disorder in the graphitic structure, and the degree of disorder and extent of defects in the graphitic structures being typically determined by the intensity ratio of the D-band to the G-band (I_{D}/I_{G}). The I_{D}/I_{G} ratio of GO (0.94) increased to 1.08 after chemical modification with the 2-imino-4-thiobiuret, suggesting an increase in the degree of disorder and number of defects in the partially reduced GO sheets of the IT-PRGO. In addition, a new Raman peak at 506 cm ⁻¹ was observed and was assigned to C-S stretching, thus providing evidence for the incorporation of amidinothiourea groups into the PRGO sheets.

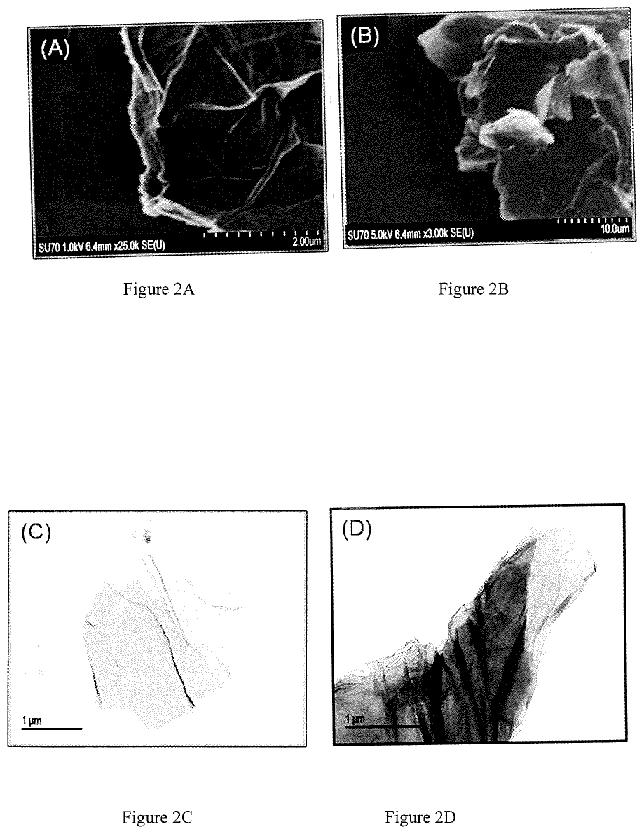

FIGS. 2(A) and 2(B) display SEM images of GO and IT-PRGO, respectively, and the corresponding TEM images are shown in FIGS. 2(C) and 2(D), respectively. Clearly, the images of GO (A and C) show a layered structure with a smooth surface due to the interactions between oxygen-containing functional groups. The wrinkled nanosheets (2B and 2D) are observed after functionalization of GO due to the grafting of the 2-imino-4-thiobiuret ligand into the surface and edges of the GO nanosheets.

Additional SEM images with EDX analysis of the IT-PRGO nanosheets before and after the adsorption of Hg(II) were acquired. The EDX analysis clearly showed the presence N, Cl and S in addition to C and O in the IT-PRGO before Hg(II) adsorption. Following Hg(II) adsorption, the EDX clearly showed the presence of Hg, and the SEM images showed high concentrations of Hg nanoparticles adsorbed within the IT-PRGO nanosheets.

The surface functional groups of GO and chemically modified GO were identified using FTIR spectroscopy. The FTIR spectrum of GO (data not shown), exhibits adsorption peaks corresponding to the stretching of hydroxyl (OH), carbonyl (C═O), epoxy (C—O), and aromatic (C═C) at wavenumbers of 3350, 1735, 1213, and 1613 cm⁻¹, respectively. Significant changes in the spectrum of GO occur upon modification with chloroacetic acid and thionyl chloride to form (GO-Cl). The intensity of the C═O stretching of the COOH group increases, which confirms the increase in the number of surface COOH groups by converting hydroxyl groups to O—CH₂COOH in GO-Cl. While the stretching of the hydroxyl groups at 3350 cm⁻¹ in GO nearly disappears in GO-Cl, the intensity of the peak at 1753 cm⁻¹, assigned to —C═O/—COOH on GO, is redshifted to 1680 cm⁻¹ due to to the C═O stretching vibrations of the Cl—CO group in GO-Cl. Also, the new bands appearing at 670, 1134, 1330 cm⁻¹ can be attributed to the stretching vibrations of the C—Cl groups. Comparing the spectrum of GO-Cl with that of IT-PRGO, the stretching vibration bands of the C—Cl groups in GO-Cl disappeared and new bands near 1350 cm⁻¹ and 1442 cm⁻¹ corresponding to C—S vibrations, and at 1035 and 1164 cm⁻¹ characteristic of —C═S vibrations were clearly observed in the IT-PRGO spectrum. Also, the bands observed at 1542 cm⁻¹ and 1680 and in the IT-PRGO spectrum can be attributed to the bending vibrations of N—H in the NH₂ group, and the C═O stretching vibration of the NHCO (amide), respectively. Furthermore, the adsorption peaks at 3071 and 3241 cm⁻¹ in the IT-PRGO spectrum are attributed to the C—N stretching vibration of the amide group, and the N—H stretching vibration of the NH₂ group, respectively.

The chemical attachment of the 2-imino-4-thiobiuret ligand onto the surface of the GO nanosheets was also evident in XPS data. Survey scans of GO and IT-PRGO showed a significant decrease in the intensity of the O1s peak and an increase in the intensity of the C1s peak in the IT-PRGO spectrum with new peaks corresponding to N1s and S2p photoelectrons clearly observed in the IT-PRGO survey scan. These observations are consistent with the covalent attachment of the 2-imino-4-thiobiuret to the GO nanosheets through chemical reactions between the amine and/or thiol groups of the IT and the oxygen functional groups and the C—Cl groups of GO-Cl. Detailed analyses of the XPS spectra of the IT-PRGO provided further confirmation for the presence of the C—O, O═C—N C═O, C—N, C═N, C—S, C—S—C, and C═S groups within the IT-PRGO nanosheets, as described below.

Deconvolution of the C1s spectrum of GO identified three components at 288.3 eV (carbonyl carbon C═O), 284.7 eV (non-oxygenated ring carbon), and 286.2 eV(C in C—O bonds). However, the C1s spectrum of IT-PRGO was deconvoluted to five peaks with binding energies of 284.7 eV (non-oxygenated carbon), 285.4 eV (C in C—N bonds), 287.9 eV (C in C═O), 286.2 eV (C in C—O or C—S bonds), and 289.1 eV (C in O═C—N or C═N). The presence of the amidoxime groups in IT-PRGO was clearly confirmed by the peaks at 285.4 eV (C in C—N bond), 289.1 eV (C in C═N or O═C—N bonds), and 286.2 eV (C in C—S bonds). The chemical shift between the carboxyl and amide groups is due to the smaller electronegativity of nitrogen as compared to oxygen.

The successful incorporation of the amidoxime groups in IT-PRGO is also evident in N1s and S2p spectra. The N1s spectrum was deconvoluted into three peaks at binding energies of 401.7 eV (N in N—H bonds), 400.2 eV (N in O═C—N bonds), and 399.2eV (N in C—N—C or C═N bonds). Similarly, the S2p spectrum was fitted to five peaks at binding energies of 162.0 eV (S in S—H bonds), 163.5 eV (S in C—S—C bonds), 164.5 eV (S in C═S bonds), 168.0 eV, and 169.4 eV (S in C—SO_{X} bonds). Therefore, the C1s, N1s and S2p XPS spectra of IT-PRGO provide clear evidence for the presence of O═C—N, C—S—C, and C—S, and C—N covalent bonds within the surface of the IT-PRGO nanosheets.

UV-VIS, FTIR, Raman and XPS analyses confirmed the formation of IT-PRGO by nucleophilic substitution reactions involving —NH₂ and/or —SH groups from the 2-imino-4-thiobiuret and the Cl—CO or the C—Cl groups of the chlorinated GO (GO-Cl), and therefore two possible structures of the IT-PRGO can be suggested as shown in FIG. 3.

### 3.2. Adsorption Capacity of Heavy Metal Ions on IT-PRGO

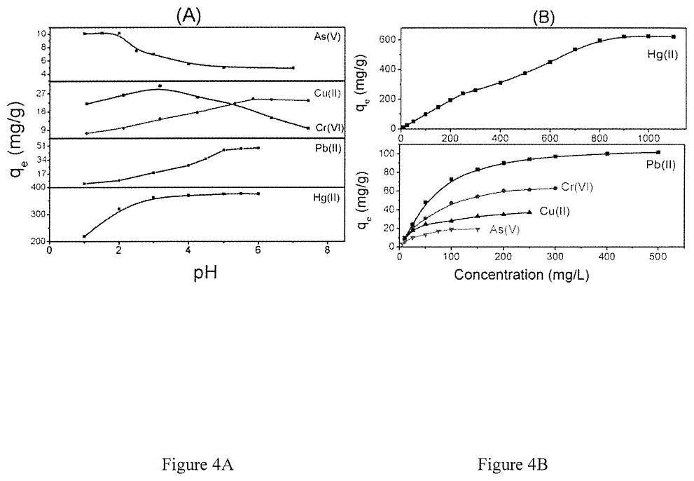

Since the pH of the solution is expected to affect the adsorption capacity of metal ions from aqueous solutions through deprotonation and protonation of the functional groups on the adsorption surface, a series of batch equilibrium measurements are conducted to investigate the effect of pH on the adsorption of Hg(II), Cu(II), Pb(II), Cr(VI) and As(V) ions by IT-PRGO. FIG. 4(A) shows the uptake plots of the metal ions onto the IT-PRGO surface at different pH values. The maximum sorption capacity is observed at pH 5.0-5.5 for Cu(II), Pb(II), and Hg(II) ions and at pH 1.0-3.0 for As(V) and Cr(VI). The predominant species of the As(V), and Cr(VI) ions are H₂AsO₄⁻, and HCrO₄, respectively, and in acidic solutions, protonation of the NH₂ groups on the surface of IT-PRGO will result in strong electrostatic attraction between the protonated amino groups of the adsorbent and the anionic species of the adsorbate. On the other hand, the adsorption capacity of Hg(II),Cu(II), and Pb(II) increases with increasing the pH of the solution, since at acidic conditions the transformation of NH₂ into NH₃⁺ results in fewer —NH₂ sites on the IT-PRGO surface available to coordinate with these metal ions. When the pH increases, protonation of the —NH₂ groups is reduced and the surface of the adsorbent has more —NH₂ groups to coordinate with the Hg(II), Cu(II), Pb(II) ions. These ions start to precipitate as hydroxides at pH>6. Therefore, the pH=5.0-5.5 is selected for further investigation of the removal of the metal ions in order to avoid metal precipitation conditions.

The effect of initial concentrations of the metal ions on the adsorption capacity of Pb(II), Hg(II), Cr(VI), Cu(II), and As(V) onto the IT-PRGO adsorbent is shown in FIG. 4(B). It is clear that that the amount of metal ions adsorbed on the IT-PRGO increases by increasing the initial concentrations of the heavy metals owing to the higher driving force of the concentration gradient at the solid-liquid interface until it reaches the state of equilibrium saturation. The results show that the efficiency of the Hg(II) removal (at pH 5) is 100% for initial concentrations up to 100 ppm and a maximum adsorption capacity of 622 mg/g could be achieved from a starting value as high as 900 ppm. For Pb(II) (at pH 5.5) the removal efficiencies are 98% and 95% for initial concentrations of 10 and 50 ppm, respectively and the maximum adsorption capacity is 100 mg/g from a starting value as high as 400 ppm. For Cr(VI) (at pH 3), Cu(II) (at pH 5.5) and As(V) (at pH 2.5), the removal efficiencies from a starting concentration of 10 ppm are 92%, 85% and 60%, respectively. The maximum adsorption capacities for As(V), Cu(II), and Cr(VI) are 19.0, 33.0, and 61.5 mg/g, from initial concentrations of 100, 150, and 250 ppm, respectively. These results demonstrate strong potential of IT-PRGO as an effective adsorbent for the removal of heavy metals from water. The adsorption ability of IT-PRGO toward Pb(II) and Hg(II) is much higher than for the other ions studied. The high adsorption capacity of IT-PRGO for the removal of Hg(II) is attributed to the sulfur low-lying empty 3d orbitals which can interact strongly with the Hg(II) ions.

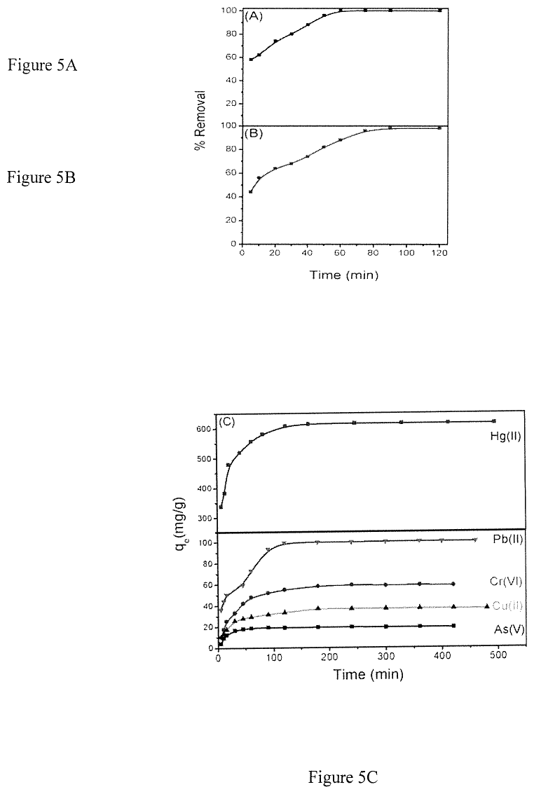

FIGS. 5(A) and 5(B) illustrate the effect of contact time on the extraction of Pb(II), and Hg(II) with initial concentrations of 25 and 50 ppm, respectively at pH 5 by the IT-PRGO nanosheets. After only 30 min contact time, the concentrations of these ions decrease from the starting values by 80% and 68%, respectively. The IT-PRGO displays excellent removal efficiency for Hg(II) reaching 100% from the initial concentration of 50 ppm within 60 min contact time as shown in FIG. 5(A). For Pb(II) the removal efficiency is 98% from the initial concentration of 25 ppm within 75 min contact time as described in FIG. 5(B). The IT-PRGO adsorbent also displays excellent performance at very high concentrations of heavy metal ions as shown in FIG. 5(C). The equilibrium contact time for the maximum removal of As(V), Cr(VI), Cu(II), Pb(II), and Hg(II) at initial concentrations 150, 250, 250, 250, 500, and 1000 ppm, respectively can be reached within 120 min contact time. Even at longer contact time up to 8 h, the amounts of metal ions adsorbed remain constant and therefore the agitation time can be optimized at 120 min for all investigated heavy metal ions.

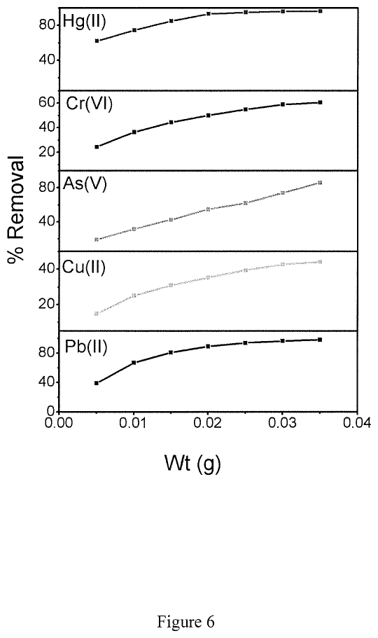

The effect of the adsorbent dose on the adsorption efficiency of Hg(II), Cu(II), Pb(II), As(V), and Cr(VI) was also studied. The results (FIG. 6) showed that the removal efficiency onto the IT-PRGO increased rapidly from 62.0% to 96.3% for Hg(II), from 38.8% to 98.3% for Pb(II), from 14.8% to 44% for Cr(VI), from 24.4 to 60.5 for Cu(II), and from 18.9 to 86.1 for As(V) when the dosage of IT-PRGO was increased from 1 g/L to 3.5 g/L. This is explained by increasing the availability of the active sites at higher dosages of IT-PRGO.

### 3.3. Adsorption Isotherms

The Langmuir isotherm model, presented by Eq. (4), based on a monolayer adsorption on a homogenous surface is used to fit the adsorption measurements.

$$\frac{{C}_{e}}{{q}_{e}} = \frac{1}{Q b} + \frac{{C}_{e}}{Q} \qquad ( 4 )$$

Where Cₑ is the equilibrium concentration of adsorbate (mg L⁻¹), b is a constant related to the energy of adsorption (Lmg⁻¹), qₑ is the amount adsorbed per unit mass of adsorbent at equilibrium (mg g⁻¹), b (Lmg⁻¹) is the Langmuir constant, and Q is the Langmuir monolayer adsorption capacity (mg g⁻¹). The parameter R_{L}, defined by Eq. 5, is used to predict the shape of the isotherm to be either linear (R_{L}=1), irreversible (R_{L}=0), favorable (0<R_{L}<1) or unfavorable (R_{L}>1). The values of Q are calculated from the slope of the linear plots of Cₑ/qₑ versus Cₑ, and b can be obtained from the intercept and slope of the plots for the studied heavy metal ions.

$${R}_{L} = \frac{1}{1 + b {c}_{0}} \qquad ( 5 )$$

The calculated parameters for the Langmuir model are summarized in Table 1. The adsorption data of the five studied metal ions fit well with the Langmuir model as indicated by the high values of the correlation coefficients (R²) in the range of 0.957-0.998. All the R_{L} values are between 0 and 0.1 indicating favorable adsorption. In addition, the maximum adsorption capacities (Qₘₐₓ) for the five metals at 25° C. are calculated to be 657.9, 37.9, 102.2, 66.2, 20.8 mg/g for Hg(II), Cu(II), Pb(II), Cr(VI), and As(V) ions, respectively in excellent agreement with the practical values as shown in Table 1. This reveals that the adsorption of the metal ions on IT-PRGO is homogenous with all the active sites have the same attraction to the adsorbates leading to a monolayer adsorption.

TABLE 1
Parameters of the Langmuir isotherms for the adsorption of
Hg(II), Pb(II), Cr(VI), Cu(II), and As(V) ions on IT-PRGO.

Langmuir parameters

| Metal ion | R² | b (L/mg) | Q_{max, fitted} | Qₑₓₚ | R_{L} |
|---|---|---|---|---|---|
| Hg(II) | 0.957 | 0.028 | 657.9 | 624.0 | 0.032 |
| Pb(II) | 0.998 | 0.118 | 102.2 | 101.5 | 0.017 |
| Cr(VI) | 0.994 | 0.067 | 66.3 | 63.0 | 0.048 |
| Cu(II) | 0.991 | 0.079 | 37.9 | 37.0 | 0.048 |
| As(V) | 0.989 | 0.082 | 20.8 | 19.0 | 0.075 |

### 3.4. Adsorption Kinetics on the IT-PRGO Surface

The second-order kinetic model proposed for understanding the mechanism of adsorption is expressed as:

$$\frac{t}{{q}_{t}} = \frac{1}{{K}_{2} {q}_{e}^{2}} + \frac{t}{{q}_{e}} \qquad ( 6 )$$

where k₂ (g mol⁻¹ min⁻¹) is the second-order rate constant of adsorption, qₑ and qₜ are the adsorbed amount (mg g⁻¹) at equilibrium and at time t (min), respectively. Values of k₂ and qₑ are calculated from the intercept and slope of the plots of t/qₜ versus t, and the calculated kinetic parameters are given in Table 2. The correlation coefficients (R²) of pseudo-second order kinetic model (R²>>0.99) are very high indicating that the adsorption kinetics of the studied ions can be well described by the pseudo-second order model, as shown in Table 2. Furthermore, the experimental value of qₑ agrees very well with the calculated values using the pseudo-second-order kinetic model as shown in Table 2. The second-order model assumes a bimolecular interaction between the adsorbate and adsorbent where sharing and exchange of electrons is involved consistent with the presence of the strong chelating amidinothiourea groups within the IT-PRGO adsorbent.

TABLE 2
Kinetic parameters for adsorption of Hg(II),
Cu(II), Pb(II), Cr(VI), and As(V) on IT-PRGO.

| | q_{e exp.} | q_{e cal.} | k₂ | |
|---|---|---|---|---|
| Metal Ion | mg · g⁻¹ | mg · g⁻¹ | g · mol⁻¹ · min⁻¹ | R² |
| Hg(II) | 624.0 | 625.0 | 0.0003 | 0.9998 |
| Pb(II) | 101.5 | 105.3 | 0.0006 | 0.9975 |
| Cu(II) | 37.0 | 38.5 | 0.0061 | 0.9994 |
| Cr(VI) | 63.0 | 62.9 | 0.0007 | 0.9987 |
| As(V) | 19.0 | 19.6 | 0.0076 | 0.9985 |

### 3.5. Mechanism for the Extraction of Heavy Metal Ions by IT-PRGO

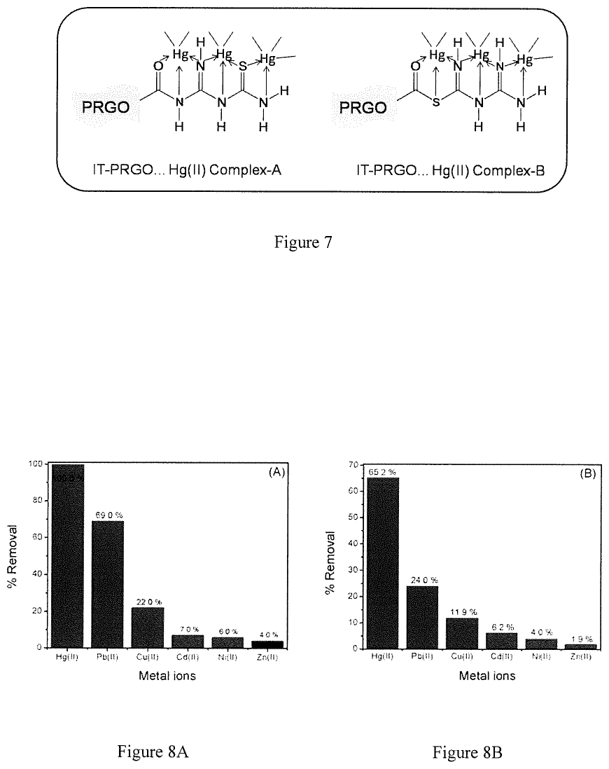

To gain more insight into the adsorption mechanism of metal ions on the IT-PRGO surface, XPS spectral analyses of the IT-PRGO adsorbent before and after the removal of metal ions were conducted. The results indicated that Hg(II) ions have strong chemical interactions with the nitrogen and sulfur atoms in the IT-PRGO adsorbent. These results suggest that the adsorption mechanism occurs through chelation processes between the Hg(II) ions and IT-PRGO as shown in FIG. 7.

### 3.6. Selectivity for the Extraction of Hg(II) Ions by IT-PRGO

The selectivity of the IT-PRGO for Hg(II) was conducted in Hg(II), Zn(II), Pb(II), Cd(II), Ni(II), and Cu(II) multiple metal ions system. FIGS. 8A and 8B and Table 3 display data showing that the removal efficiency for Hg(II) ions was larger than that for other metal ions. Hence, the IT-PRGO adsorbent has a superior selectively for Hg(II) ions from the mixed metal ions solution, and can be used to extract Hg(II) ions from contaminated water.

TABLE 3
Adsorption capacities of IT-PRGO in mixed metal ion system.

| Metal ion | Hg(II) | Pb(II) | Cu(II) | Cd(II) | Ni(II) | Zn(II) |
|---|---|---|---|---|---|---|
| Initial concentration | 250.0 | 250.0 | 250.0 | 250.0 | 250.0 | 250.0 |
| mg/l | | | | | | |
| Final Concentration | 87.0 | 190.0 | 220.0 | 235.0 | 240.0 | 245.2 |
| mg/l | | | | | | |
| Adsorption capacity | 163.0 | 60.0 | 30.0 | 15.0 | 10.0 | 4.8 |
| mg/g | | | | | | |

3.7. Desorption Studies from the Surface of IT-PRGO

For economically feasible wastewater treatments with adsorption, the regeneration of the adsorbent is one of the most important challenges that need be addressed by a practical and simple approach. Tables 4, 5, 6, and 7 show the results of different eluents used for the recovery of Pb(II), Hg(II), Cr(VI), Cu(II), and As(V) from the metal loaded IT-PRGO. The results indicate that Hg(II) can be easily regenerated with 5 ml of (6% thiourea+2 M HNO₃) with recovery of more than 95.0%. The desorption of Pb(II) and Cu(II) increases from 50.9% to 100% and from 66.6 to 100%, respectively, when the concentration of nitric acid increases from 0.5 mol/L to 1.5 mol/L. The desorption of As(V) and Cr(VI) increases from from 41.0% to 100%, and 47.3% to 95.9%, when the concentration of NaOH increases from 0.2 mol/L to 1.0 mol/L. These results demonstrate that IT-PRGO exhibits high efficiency and is amenable to recycling/reuse, and thus represents a low cost material for waste water treatment.

TABLE 4
Desorption studies of Hg(II) from IT-PRGO using
different eluents after adsorption of 1000 ppm.

| | qₑ Adsorbed | qₑ Desorbed | |
|---|---|---|---|
| Eluent | (mg/g) | (mg/g) | % Desorption |
| 1M HNO₃ | 622.00 | 83.52 | 13.42 |
| 1M HCl | 622.00 | 60.51 | 9.72 |
| 6M HNO₃ | 622.00 | 154.43 | 24.82 |
| 0.01 EDTA | 622.00 | 72.80 | 11.7 |
| 2% EDTA | 622.00 | 125.25 | 20.13 |
| 0.1M HNO₃ + | 622.00 | 176.71 | 28.40 |
| 2% Thiourea | | | |
| 2M HNO₃ + | 622.00 | 410.37 | 65.97 |
| 4% Thiourea | | | |
| 2M HNO₃ + | 622.00 | 595.11 | 95.67 |
| 6% Thiourea | | | |

TABLE 5
Desorption studies of Pb(II) from IT-PRGO using
different eluents after adsorption of 250 ppm.

| | qₑ Adsorbed | qₑ Desorbed | |
|---|---|---|---|
| Eluent (HNO₃) | (mg/g) | (mg/g) | % Desorption |
| 0.1 | 94.00 | 47.80 | 50.85 |
| 0.5 | 94.00 | 94.07 | 100.07 |
| 1.0 | 94.00 | 94.05 | 100.05 |

TABLE 6
Desorption studies of Cu(II) from IT-PRGO using
different eluents after adsorption of 250 ppm.

| | qₑ Adsorbed | qₑ Desorbed | |
|---|---|---|---|
| Eluent (HNO₃) | (mg/g) | (mg/g) | % Desorption |
| 0.5 | 37.00 | 24.65 | 66.62 |
| 1.0 | 37.00 | 29.07 | 78.56 |
| 1.5 | 37.00 | 38.02 | 100.02 |

TABLE 7
Desorption studies of Cr(VI) from IT-PRGO using
different eluents after adsorption of 250 ppm.

| | qₑ Adsorbed | qₑ Desorbed | |
|---|---|---|---|
| Eluent (NaOH) | (mg/g) | (mg/g) | % Desorption |
| 0.2 | 61.50 | 29.06 | 47.25 |
| 0.4 | 61.50 | 45.33 | 73.70 |
| 0.8 | 61.50 | 53.50 | 86.99 |
| 1 | 61.50 | 59.00 | 95.93 |

3.8. Comparison of IT-PRGO with other Adsorbents

To demonstrate the remarkable efficiency of IT-PRGO for Hg(II) removal, Table 8 compares the values of qₘₐₓ for the Hg(II) removal by IT-PROG and other prior art adsorbents. As can be seen, IT-PRGO exhibits one of the highest qₘₐₓ values for the removal of Hg(II) ions from water. The Hg(II) removal capacity of IT-PRGO (624 mg/g) is even higher than most of the benchmark highly porous materials including MOF Zr-DMBD (197 mg/g), COF-LZU8 (236 mg/g), porous carbon (518 mg/g), and mesoporous silica (600 mg/g). It should be noted that the performance of IT-PRGO is comparable to those of the imine-linked and thiol-linked COFs which are considered the best porous materials for the Hg(II) removal from aqueous solutions. However, the complicated post synthesis modifications and the high cost associated with the synthesis and activation of these materials make IT-PRGO a more realistic candidate for waste water treatment applications.

TABLE 8
Adsorption capacities of various adsorbents for Hg(II) ions.

| | q_{e max} |
|---|---|
| Adsorbent | (mg/g) |
| IT-PRGO | 624 |
| GO-2-pyridinecarboxaldehyde | 555 |
| thiosemicarbazone | |
| Layered double hydroxide with MoS₄²⁻ | 500 |
| KMS-1 | 377 |
| KMS-2 | 297 |
| GO-thiol-functionalized magnetite | 163 |
| Mercarptosuccinic acid-LDH | 161 |

IT-PRGO also shows superior removal capacity of Pb(II) ions (101.5 mg/g) compared to other GO based materials such as chitosan-GO (99 mg/g) and magnetic chitosan-GO (79 mg/g), and comparable performance to the recently reported Hg-Al layered double hydroxide-PRGO (116.2 mg/g). For the removal of Cr(VI) ions, the IT-PRGO (63 mg/g) performs better than Fe₃O₄-GO (54 mg/g) and CTAB modified GO (21.6 mg/g) adsorbents. Similarly, for the extraction of Cu(II) ions, IT-PRGO shows a removal capacity of 34 mg/g as compared to 18.3 mg/g and 3.3 mg/g for Fe₃O₄-GO and MWCNT adsorbents, respectively.

### 4. Conclusions and Outlook

A novel chelating adsorbent IT-PRGO for the adsorptive extraction of heavy metal Hg(II), Cu(II), Pb(II), Cr(VI), and As(V) ions from water was developed by grafting a simple and cost effective 2-imino-4-thiobiuret ligand on the surface of partially reduced graphene oxide nanosheets. The IT-PRGO exhibits performance in both capacity and selectivity superior to most of the reported materials used for the extraction of toxic metal ions from water. It displays a 100% removal of Hg(II) at concentrations up to 100 ppm and the adsorption is exceptionally rapid showing 90%, 95%, and 100% removal by 15 min, 30 min, and 90 min, respectively at 50 ppm concentration. The maximum adsorption capacity of 624 mg/g is achieved from a starting concentration as high as 900 ppm Hg(II) ions. For Cu(II), and Cr(VI), and Pb(II) at a concentration of 10 ppm, the removal efficiency is 85%, 92% and 98%, respectively. In a mixture of six heavy metal ions containing 10 ppm of each ion, the IT-PRGO shows a 4% Zn(II), 6% Cd(II), 7% Ni(II), 22% Cu(II), 69% Pb(II), and 100% Hg(II). This remarkable efficiency and selectivity is attributed to the combination of the amidoxime functional groups with the large surface area of the partially reduced graphene oxide nanosheets. Sorption isotherms of all the ions studied agree with the Langmuir model suggesting a monolayer adsorption. The sorption kinetics can be fitted well to a pseudo-second-order kinetic model which suggests a chemisorption mechanism via the imidinothiourea groups grafted on the reduced graphene oxide nanosheets. Desorption studies demonstrate that the IT-PRGO is easily regenerated with the desorption of the heavy metal ions Hg(II), Cu(II), Pb(II), Cr(VI), and As(V) reaching 96%, 100%, 100%, 96% and 100%, respectively from their maximum sorption capacities using different eluents. The IT-PRGO is a top performing remediation adsorbent for the extraction of toxic metal ions from polluted water.

### Example 2

### Effective Removal of Mercury(II) from Aqueous Solutions by Chemically Modified Graphene Oxide Nanosheets

The present Example describes the development of a multi-functional GO adsorbent for high efficiency removal of Hg(II) from aqueous solutions. The major objective of this work was to develop and characterize chemically modified Improved GO (IGO) nanosheets containing imino groups (Imino-IGO) and evaluate their potential for Hg(II) removal from aqueous solutions through detailed studies of the isotherms and thermodynamics of their adsorption, in comparison with the parent IGO nanosheets and those containing extra carboxylic groups (IGO-COOH).

### Experimental Section

Materials. Graphite powder of high purity 99.5% was used. The oxidizing mixture was concentrated 98% H₂SO₄, 99% H₃PO₄ and 99% KMnO₄. Other chemicals used: 30% H₂O₂, 99% SOCl₂, 99% Tri ethylamine, 99% ethylene diamine, 99% choro-acetic acid (ClCH₂COOH), mercuric chloride (HgCl₂), were commercially available and were used as received without further purification. All reagents were bought from Sigma Aldrich. Deionized (DI) water was used in all experiments.
Preparation of improved graphene oxide IGO. IGO was prepared according to the method described in Marcano, et al. ACS Nano, 4 (2010) 4806-4814. A 9:1 mixture of concentrated H₂SO₄/H₃PO₄ (540:60mL) was added to a mixture of graphite flakes (4.5 g) and KMnO₄ (27.0 g) and maintained below 30° C. using an ice bath. The reaction was then heated to 50° C. and stirred for 12 hours. The reaction was cooled to room temperature and poured onto ice (600 mL) containing 30% WO, (4.5 mL). The mixture was then centrifuged and the remaining solid material was washed in succession with 200 mL of water, 200 mL of 30% HNO₃, and 200 mL of 2% ethanol. The IGO was then vacuum dried overnight at 60° C.
Preparation of acetic acid functionalized IGO (IGO-COOH). The prepared IGO (0.5 g) was dispersed in 500 mL DI water for 1 hour to give a clear solution. 10 g (Cl—CH₂COOH) and 12 g NaOH were added to the IGO solution and sonicated for 3 hours, then the mixture the pH of the solution was adjusted to 6.5 using HNO₃. The product was centrifuged, washed with DI water several times and dried in an oven at 70° C. for 12 hours.
Preparation of acyl-chloride functionalized IGO (IGO-Cl). 0.5 g of IGO-COON was well dispersed in 10 mL anhydrous DMF by sonication for 1 hour and then was treated with SOCl₂ (75mL) at 80° C. for 3 days. The product was separated by centrifugation, washed with anhydrous DMF and dried under vacuum.
Preparation of ethylene diamine functionalized IGO (IGO-NH₂). A dispersion of IGO-Cl (0.5 g) in 15 mL anhydrous DMF (75mL) ethylene diamine and (2mL) Et₃N were placed in a around bottom flask and refluxed at 80° C. for 48 hours. After the reaction, the solution was cooled to room temperature, filtered, and washed with ethanol/DI water (1:1) for several times and then dried in an oven at 70° C. for 10 hours.
Preparation of imino-diacetic acid functionalized IGO (Imino-IGO). In a typical reaction, 0.2 g of IGO-NH₂ was dispersed in 300 ml carbonate buffer (pH 9.5-10) and 11.24 g ClCH₂COOH was added and sonicated for 15 min. The pH maintained at (pH=9.5-10) during the reaction. The mixture was stirred and refluxed for 10 hours at 70° C. The product was filtered and washed with DI water several times and dried in an oven at 70° C.
Characterization. The IGO and functionalized IGO were characterized by FT-IR spectroscopy using the Nicolet-Nexus 670 FTIR Spectrometer (4 cm ⁻¹ resolution and 32 scan), Diamond Attenuated Total Reflectance (DATR), X-ray diffraction using an X'Pert Philips Materials Research Diffractometer, X-ray Photoelectron Spectroscopy (XPS) using the Thermo Fisher ESCAlab 250, SEM using the Hitachi SU-70 FE-SEM, TEM using the Jeol JEM-1230 microscope, and Raman spectroscopy using the Thermo Scientific DXR Smart Raman with 532 nm excitation.
Removal of Hg (II) ions using batch method. The Adsorption of Hg(II) ions was studied in batch experiments using a series of 20 mL glass vials containing 10 mL of Hg(II) ions solution at the desired initial concentration, pH, and agitation time. The residual concentration of Hg(II) ions was measured by using Inductively Coupled Plasma Atomic Emission (ICP-OES) where the samples were acidified with 2% HNO₃ prior for analysis. The amount of mercury adsorbed per unit mass of adsorbent (IGO, IGO-COON and Imino-IGO) and the percentage of removal were calculated as follows [38].

$$\begin{matrix}Extraction \% = \frac{( {C}_{0} - {C}_{e} )}{{C}_{0}} \times 100 & ( 1 ) \\ {q}_{e} = \frac{( {C}_{0} - {C}_{e} ) V}{m} & ( 2 )\end{matrix}$$

where qₑ is the adsorption capacity (mg/g), Cₒ and Cₑ are the initial and equilibrium concentration Hg (II) ions (mg/L), respectively, m is the mass of adsorbent (g), and V is the volume of testing solution of Hg (II) ions (L).
Regeneration and Recycling Studies. For the desorption experiments, Hg-loaded adsorbent was collected from the suspension by centrifugation and was slightly washed with DI water and dried at 60° C. Then, certain amount of adsorbent loaded with Hg(II), was placed in a series of glass vials containing 10 mL of different eluents (0.2-1.0 M HCl, 0.01 EDTA) and the mixture was stirred at 25° C. for 5 hours. The final concentration of Hg(II) ions in the eluent was determined by ICP-AES. After desorption, the recovered adsorbent was treated with 0.005 M NaOH to restore the pH of the surface to pH 5 then washed with deionized water several times and then dried in at 80° C. and subjected to the next five adsorption-desorption with the same procedure described above.

### Results and Discussion

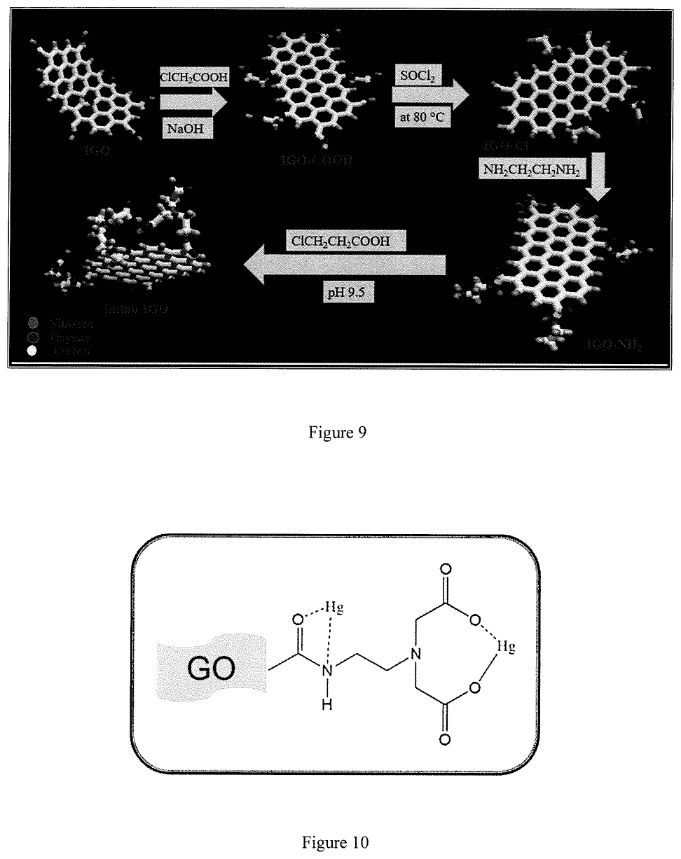

The design strategy of the current adsorbent systems is based on the introduction of oxygen and nitrogen chelating groups within chemically functionalized IGO as shown in FIG. 9. The IGO was produced by oxidation of graphite using H₃PO₄/H₂SO₄/KMnO₄. IGO was first modified with chloroacetic acid to increase the negative charge and the number of carboxyl groups on the surface by converting hydroxyl groups to O—CH₂COOH followed by reaction with SOCl₂ to convert the oxygen-containing groups (hydroxyl, carboxyl) into acyl chloride groups which can react with ethylene diamine. The final step is the incorporation of the imino-diacetic acid chelating groups by the reaction of the unreacted amino group in ethylene diamine with chloroacetic acid in basic medium. Since imino diacetic functional groups could supply NH functional groups, the adsorption capacity for the removal of mercury is expected to increase significantly.

UV-Vis adsorption spectra of the IGO, IGO-COOH, and Imino-IGO nanosheets dispersed in water were obtained. The three spectra showed two major bands: a maximum between 208-240 nm, which can be related to the π-π* adsorption of aromatic C═C bonds; and a shoulder at 295 nm assigned to n-π* transitions of the C═O, C—O, and C—N bonds. It was clear that the IGO-COOH sample showed a strong adsorption peak at 240 nm indicating the presence of a large number of conjugated C═C and C═O groups. A red shift of the π-π* transition of the aromatic C═C bond to 248 nm in IGO-COOH indicated the partial reduction of IGO and the restoration of some of the C═C bonds in the IGO-COON sheets. This is also consistent with the change in color from brown of the IGO solution to black in the IGO-COOH solution.

The surface functional groups of the prepared samples IGO, IGO-COOH, IGO-Cl, IGO-NH₂, and Imino-IGO were confirmed by FT-IR spectra. The spectrum of IGO showed broad adsorption peaks at 3350 and 1735 cm⁻¹ related to the O—H and C═O stretching vibrations in the carboxylic acid groups at the IGO surface. The spectrum also showed weak characteristic bands at 1200, 1050, and 830 cm⁻¹ assigned to the C—OH stretching, symmetric, and asymmetric stretching vibrations in the epoxy groups, respectively. The spectrum of the IGO-COON depicted the same adsorption peaks of IGO but with higher intensity confirming the increase in the number of carboxylic groups on the surface of IGO. Following the addition of thionyl chloride, the spectrum of IGO-Cl showed a band at 1690 cm⁻¹ assigned to C═O stretching of the Cl—CO group. Also, peaks at 670, 1134, 1330 cm⁻¹ corresponded to the stretching vibrations of the C—Cl group. Following the addition of ethylene diamine, the spectrum of IGO-NH₂ showed peaks around 1650 and 1500 cm⁻¹ attributed to the C═O stretching vibration of NHCO (amide) group and the bending vibration of N—H in the NH₂ group, respectively. Peaks at 3254 and 1060 cm⁻¹ were assigned to the N—H and C—N stretching vibrations of the C—NH₂ group, respectively. Finally, the Imino-IGO spectrum showed a strong peak at 3350 cm⁻¹, due to the stretching vibration of O—H in the carboxylic acid group. Peaks in the range of 1550-1350 cm⁻¹ were attributed to asymmetric and symmetric COO⁻ stretches. The FT-IR spectra of the intermediate and final products confirmed the successful grafting of desired functional groups on the surface of improved graphene oxide.

Raman spectra of the IGO, COOH-IGO and Imino-IGO sheets showed the two characteristic G and D bands. The G band is associated with the stretching vibration of the conjugated C═C groups and it appeared at almost the same frequency of 1592 cm⁻¹ in IGO and COOH-IGO with a slight blue shift in Imino-IGO (1598 cm⁻¹) which could be due to charge transfer from the imino functional groups to the IGO sheets. The intensity ratio of the D-band to the G-band is usually used as a measure of the degree of disorder and defects in the graphitic structures. The I_{D}/I_{G} in the COOH-IGO (1.07 at excitation wavelength 532 nm) was slightly higher than that of IGO (0.95 at excitation wave length 532 nm) indicating a small increase in the disordered structures. The appearance of a new band at 1465 cm⁻¹ in COOH-IGO, which shifts to 1465 cm⁻¹ in Imino-IGO, could be due to the covalent interactions of the imino-diacetic acid with the IGO sheets.

The X-ray Diffraction patterns (XRD) of IGO, COON-IGO, and Imino-IGO showed a sharp peak of IGO at 2θ=10.55° corresponding to an interlayer distance of 0.801 nm and was attributed to the oxygen-containing groups on the IGO sheets. This peak is shifted to 2θ=11.50° with an interlayer spacing of 0.75 nm in IGO-COOH which may be due to the distortion of the crystal structure of IGO with the reaction of chloroacetic acid in basic medium. The XRD pattern of Imino-IGO showed a new sharp peak at 2θ=6.8° corresponding to a large interlayer distance between the sheets due to the presence of the large functional groups —O—CH₂CONHCH₂CH₂N(CH₂COOH)₂ on the surface of the Imino-IGO sheets. The disappearance of the peak at 2θ=10.55° provided evidence for the reduction of IGO. The broad peak at 2θ=24.5° with an interlayer spacing of 0.35 nm suggested the presence of stacked Imino-IGO graphene like platelets.

TEM and SEM images of the IGO and the chemically modified IGO sheets were obtained. The TEM images indicated that the IGO sheets have smooth surfaces and appear to be thicker than the thin and slightly crumpled chemically modified sheets (IGO-COOH and Imino-IGO) which appeared to have rougher and more wrinkled surfaces, probably because of the covalent attachments of the oxygen and nitrogen containing functional groups. The SEM images showed a graphene-like flake shape morphology with more leaf-like veins especially in the Imino-IGO sheets.

The XPS C1s and O1s spectra of IGO before and after the adsorption of Hg(II), the Hg 4f spectrum of IGO after the adsorption of Hg(II), and the corresponding XPS data for IGO-COOH and Imino-IGO before and after the adsorption of Hg(II)were obtained. Deconvolution of the C1s spectrum identified three components at 284.7 eV (non-oxygenated ring carbon), 286.2 eV(C in C—O bonds) and 288.3 eV (carbonyl carbon C═O). The O1s peak at 531.1 eV was assigned to the oxygen bound to carbon. After Hg (II) adsorption, it is clear that the relative intensities of both C—O and C═O peaks are more pronounced due to the interaction of Hg(II) with the oxygenated carbon. Moreover, the appearance of a strong shoulder at 533.5 eV in the O1s spectrum confirmed that charge transfer from oxygen to Hg(II) has occurred following the adsorption of Hg(II). Similar observations were found in the O1s spectra of IGO-COOH and Imino-IGO following the adsorption of Hg(II). The XPS data also confirmed a significant decrease in the intensity of the C1s peak of the C—N bond in Imino-IGO following the adsorption of Hg(II) which is consistent with charge transfer from the C—N bond in Imino-IGO to Hg(II). The presence of Hg(II) in all the IGO, IGO-COOH and Imino-IGO samples after the adsorption experiments was clearly evidenced by the two distinguishing peaks for the 4f^{7/2} and 4f^{5/2} electrons of Hg(II) at binding energies of 100.5 eV and 104.6 eV, respectively, with a spin-orbital splitting of 4.1 eV for IGO.

In summary, UV-VIS, FTIR, Raman and XPS analyses confirmed the formation of IT-COOH and UV-IT-PRGO. In particular, the formation of IT-PRGO by nucleophilic substitution reactions involving —NH₂ and/or —SH groups from the 2-imino-4-thiobiuret and the Cl—CO or the C-Cl groups of the chlorinated GO (GO-Cl) were confirmed, and therefore two possible structures of the IT-PRGO can be suggested as shown in FIG. 3. In particular, the XPS results also showed that after the adsorption of Hg(II) on the Imino-IGO sheets, the intensity of the O1s peak corresponding to O═C—O— was reduced significantly and a new peak corresponding to O═C—O . . . Hg appeared. Based on the changes in the XPS of the C1 s and O1s of the Imino-IGO following the adsorption of Hg(II), it can be concluded that the mechanism of removal of the Hg ions depends mainly on complexation with the carboxylic groups in the imino-diacetic acid IGO surface as shown in FIG. 10.

Various metal-binding mechanisms are thought to be involved in the removal process, including ion exchange (release of H+), surface adsorption, chemisorption and adsorption-complexation (Imino group). Metal-binding mechanisms may be assumed to involve the following three steps: migration of Hg(II) from bulk of the solution to the surface of the adsorbent; diffusion of Hg(II) through the boundary layer to the surface of the adsorbent; and adsorption of Hg(II) at the active sites (COON, O═C—NH, NH₂) on the surface of different adsorbents with release of protons.

### Adsorption Parameters of the Hg(II) Ions by the Chemically Modified IGO Sheets

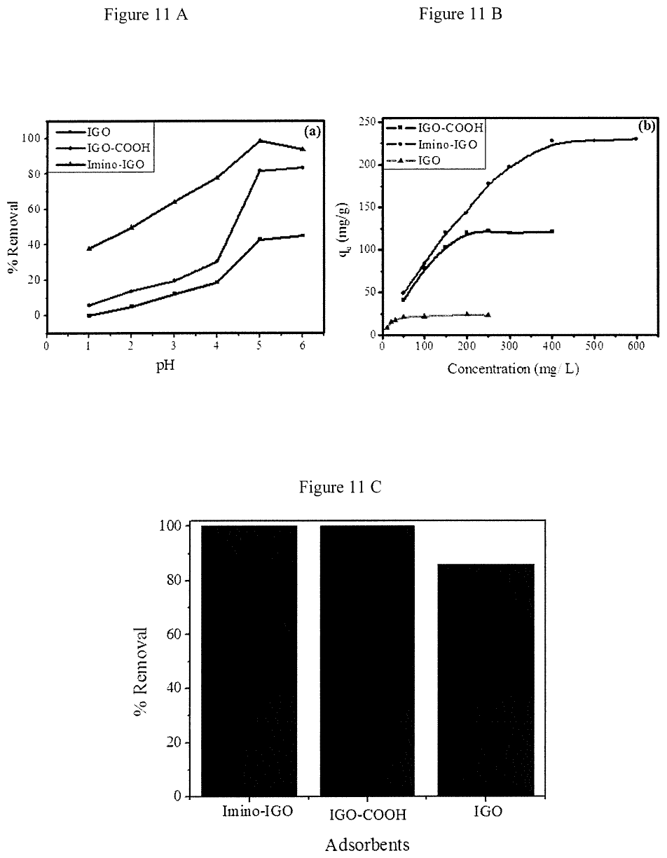

The effect of the initial pH on the removal of Hg(II) using IGO, IGO-COOH, and Imino-IGO nanosheets is shown in FIG. 11(A). The adsorption capacity increased when the pH increased and maximum adsorption of Hg(II) ions occurred at pH 5. When the pH increases from pH 1 to pH 6, the amount of Hg (II) ions adsorbed at equilibrium (qₑ) increases from 0 to 22.4 mg/g, from 2.8 to 41.60 mg/g, and from 18.80 to 49.2 mg/g for IGO, IGO-COOH and Imino-IGO, respectively. The effect of pH is expected because of the presence of various oxygen containing functional groups such as carboxyl groups and hydroxyl groups in IGO and IGO-COOH, and amide groups in Imino-IGO. The electrostatic and ionic interaction between the Hg(II) ions and different adsorbents at different pH values could play a vital role in the adsorption process. The decrease in the removal efficiency of Hg(II) ions at low pH values can be attributed to competition between Hg(II) ions and hydrogen ions for the adsorption sites of different adsorbents. The hydrogen ion is a strong competitor for adsorption due to its small size. At high pH values, the repulsion forces became weaker and the mercury ions may be transported to the surface of the adsorbent due to the electrostatic attraction between the negatively charged surface and the Hg(II) ions. The high maximum adsorption at pH 5 is explained by the decrease of the solubility of mercury due to extensive hydrolysis (the percentage of HgClOH and Hg(OH)₂ species increases).

The effect of the initial concentration on the removal of Hg(II) ions using IGO, IGO-COOH, Imino-IGO at the optimum pH=5 and at room temperature, is shown in FIG. 11(B). The results show that the equilibrium sorption capacities of the sorbents increase with increasing the initial Hg (II) ion concentration. This is because the higher the initial Hg(II) ion concentration, the higher the driving force of the concentration gradient at solid-liquid interface which causes an increase of the amount of Hg(II) ions adsorbed on the adsorbent. When the initial concentration of Hg(II) ions increases from 10.0 to 250.0 mg/L for IGO, from 50.0 to 400.0 mg/L, and from 50.0 to 600.0 mg/L for Imino-IGO at 25° C., the amount of Hg(II) ions adsorbed at equilibrium (qₑ) increases from 8.6 to 24.0 mg/g, from 40.7 to 122.0 mg/g, and from 49.2 to 230.0 mg/g for IGO, IGO-COOH, Imino-IGO, respectively. The removal efficiency of mercury at the highest concentrations of 250.0, 400 and 600 mg/L decreases from 86.0% to 9.2%, from 81.5% to 30.3%, and from 98.4% to 38.3% for IGO, IGO-COOH and Imino-IGO, respectively. This decrease is probably related to the blockage of the hydroxyl and carboxyl groups at higher concentrations of Hg(II) ions. As expected, the adsorption efficiency increased with the initial Hg(II) ion concentration as shown in FIG. 11(B). With more Hg(II) ions present in solution, a larger fraction of the active sites is involved in the adsorption process and the adsorption efficiency reaches a plateau indicating saturation of the available binding sites on the adsorbent. It should be noted that at very low concentrations of Hg(II) such as 10 ppm, a 100% removal can be achieved by both the IGO-COOH and Imino-IGO adsorbents as shown in FIG. 11C.

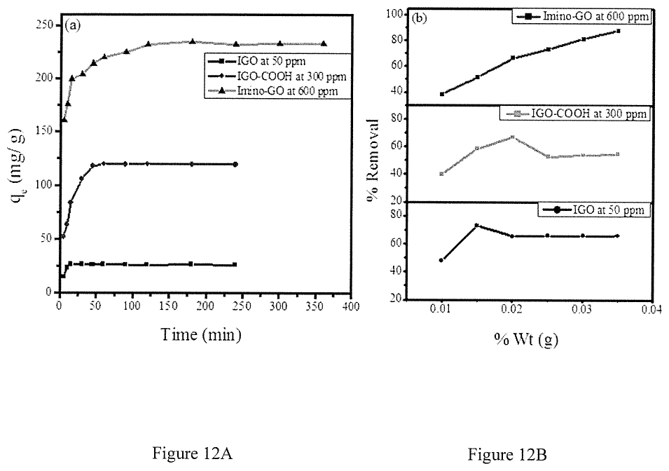

FIG. 12(A) illustrates the effect of contact time on the adsorption capacity of IGO, IGO-COOH, and Imino-IGO for the Hg(II) ions with concentrations of 50, 300 and 600 ppm at pH 5. It is clear that an initial rapid increase in the removal efficiency occurs where a large fraction of the total amount of Hg(II) ions is removed within 5 minutes reaching more than 43.0%, 57.0%, and 69.0% of the maximum adsorption capacity for IGO, IGO-COOH and Imino-IGO, respectively. This means that a large number of vacant adsorption sites on the adsorbent's surface is available at this stage. Thereafter, the adsorption rate becomes slower at the adsorption equilibrium and the maximum removal of Hg (II) ions occur within 30 min, 60 min, and 120 min for IGO, IGO-COOH, Imino-IGO, respectively. At these times, the amount of mercury being adsorbed onto the adsorbent is in equilibrium with the amount desorbed from the adsorbent.

The dependence of the removal of Hg(II) ions on the dosage of IGO, IGO-COOH and Imino-IGO is shown in FIG. 12(B). The increase in the sorbent's dose with the percent of Hg(II) removal is almost linear for the Imino-IGO nanosheets. When the sorbent's dose increases from 0.01 to 0.035 g, the percent of mercury removal using IGO, IGO-COOH and Imino-IGO increases from 48.0% to 65.8%, from 39.8% to 54.60%, and from 38.3% to 87.8%, respectively. This can be related to the availability of more sorption sites and the increased in the total sorbent surface area with increasing the dosage. However, at higher dosages the sorbents' particles aggregate leading to a decrease in the total surface area of the adsorbent and consequently a decrease in the removal capacity. This behavior is observed for IGO and IGO-COOH when the dosage is increased to 0.035 g where the percent of Hg(II) removal levels off at 65.8% and 54.60% for initial Hg(II) ion's concentrations of 50 and 300 ppm, respectively. Interestingly, Imino-IOG at the same dosage of 0.035 g and an initial Hg(II) ion's concentration of 600 ppm, the percent removal does not reach a plateau indicating no saturation of the available binding sites.

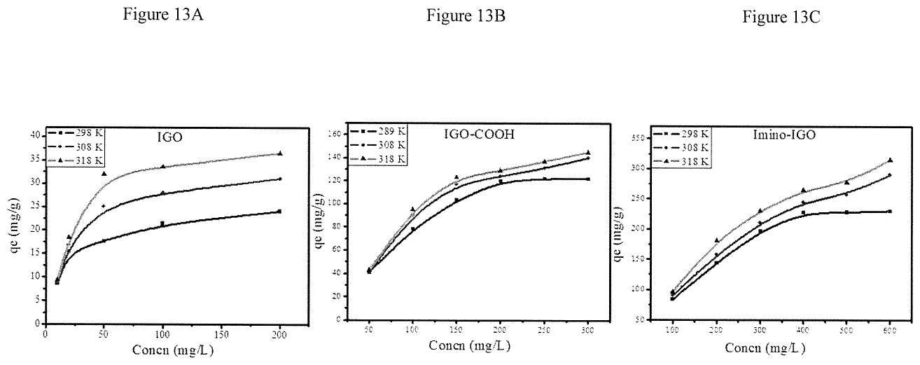

FIG. 13A-C and Table 9 illustrate the effects of temperature on the adsorption capacity of Hg(II) ions using the IGO, IGO-COO and Imino-IGO adsorbents. The results indicate that the maximum adsorption capacity of mercury using IGO, IGO-COOH, and Imino-IGO increases from 24.0 to 36.5 mg/g, from 122.0 to 145.0 mg/g, and from 230.0 to 315.0 mg/g, respectively, when the temperature is increased from 298 K to 318 K. This effect is attributed to the increase in the kinetic energy and mobility of Hg(II) ions in solution with temperature. The above results clearly establish that maximum adsorption capacity of Hg(II) from water by the chemically modified GO adsorbents increases in the order of Imino-IGO>IGO-COON>IGO under all experimental conditions studied such as pH, Hg(II) ion's concentration, temperature, and sorbent dose.

TABLE 9
Effect of temperature on the maximum adsorption capacities
of Hg(II) ions on IGO, IGO-COOH and Imino-COOH.

| | Qₑ(mg g⁻¹) | | |
|---|---|---|---|
| Adsorbents | 298 K | 308 K | 318 K |
| IGO | 22.0 | 31.0 | 36.5 |
| IGO-COOH | 122.0 | 140.0 | 145.0 |
| Imino-IGO | 230.0 | 290.0 | 315 |

### Adsorption Isotherms

The batch adsorption isotherms for Hg(II) ions by IGO, IGO-COOH, and Imino-IGO determined based on the Langmuir and Freundlich models were determined. The Langmuir model assumes homogeneity of adsorption surface with all the adsorption sites having equal adsorption affinity (Eq. 3), while the Freundlich model would suggest heterogeneity of the adsorption surface sites (Eq. 4).

$$\begin{matrix}Langmuir isotherm \frac{{C}_{e}}{{q}_{e}} = \frac{1}{b {Q}_{0}} + \frac{{C}_{e}}{{Q}_{0}} & ( 3 ) \\ Freundlich isotherm ln {q}_{e} = ln {K}_{f} + \frac{1}{n} ln {C}_{e} & ( 4 )\end{matrix}$$

where Cₑ is the equilibrium concentration of the Hg(II) ions (mg L⁻¹), qₑ is the amount adsorbed per unit mass of adsorbent at equilibrium (mg g⁻¹), b is a constant related to the energy of adsorption (Lmg⁻¹), Q, is the Langmuir monolayer adsorption capacity (mg g⁻¹), K_{f} is an indicator of the adsorption capacity, and 1/n is the adsorption intensity. The calculated parameters for the Langmuir and Freundlich isotherms are summarized in Table 10.

The plots clearly indicated that the adsorption behaviors of IGO, IGO-COOH, and Imino-IGO can be well represented by the Langmuir rather than the Freundlich model. The maximum monolayer adsorption capacity (Qₘₐₓ) calculated from the Langmuir's model for IGO, IGO-COOH, and Imino-IGO at 25° C. (23.05, 128.21, and 247.52 mg/g, respectively) compare very well with the experimentally determined values of 24.0, 122.0 and 230.0, mg/g, respectively as shown in Table 10. Moreover, insight into the nature of the Hg(II) adsorption isotherm can be obtained by calculating the Langmuir R_{L} parameter defined by Eq. 5.

$${R}_{L} = \frac{1}{1 + b {c}_{0}} \qquad ( 5 )$$

Where b (Lmg⁻¹) is the Langmuir constant and Cₒ is the initial Hg(II) concentration (mg L⁻¹). The value of R_{L} indicates the shape of the isotherm to be either unfavorable (R_{L}>1), linear (R_{L}=1), favorable (0<R_{L}<1) or irreversible (R_{L}=0). As shown in Table 10, all the R_{L} values determined lie between 0 and 1 indicating favorable adsorption for Hg(II) on the IGO, IGO-COOH, and Imino-IGO nanosheets.

TABLE 10
Parameters of Langmuir and Freundlich isotherm models for the
removal of Hg(II) ions using IGO, IGO-COOH, and Imino-IGO.

| | Langmuir parameters | | | | | | | |
|---|---|---|---|---|---|---|---|---|
| | | b | Q_{max, Calc} | Q_{Exp} | | Freundlich parameters | | |
| Adsorbent | R² | (L/mg) | (mg/g) | (mg/g) | R_{L} | R² | K_{f} | 1/n |
| IGO | 0.984 | 0.220 | 23.050 | 24.0 | 0.018 | 0.759 | 10.402 | 0.160 |
| IGO- | 0.996 | 0.081 | 128.205 | 122.0 | 0.030 | 0.768 | 26.869 | 0.302 |
| COOH | | | | | | | | |
| Imino-IGO | 0.992 | 0.039 | 247.520 | 230.0 | 0.040 | 0.945 | 48.375 | 0.279 |

### Estimation of Thermodynamic Parameters

The enthalpy change ΔH°, the free energy change ΔG°, and the entropy change ΔS° for the adsorption of Hg(II) onto the IGO, IGO-COOH and Imino-IGO adsorbents were calculated from van't Hoff plots of temperature dependence of the adsorption coefficient (K_{d}) defined by Eq. (6), where p=1000 g/L makes a dimensionless K_{d}.

$${K}_{d} = \frac{{q}_{e}}{{c}_{e}} * ρ \qquad ( 6 )$$

The thermodynamic parameters (ΔG°, ΔH° and ΔS°), given in Table 11, confirm the spontaneous nature of the sorption process of Hg(II) by the IGO, IGO-COOH, and Imino-IGO adsorbents. The positive value of ΔH° confirms the endothermic nature of the sorption process consistent with the increase in the maximum adsorption capacity with increasing temperature. The positive ΔS° values indicate an increase of the disorder at the solid/solute interface during the adsorption process resulting from the liberation of water molecules solvating the metal ion to the solution.

TABLE 11
Thermodynamic parameters for adsorption
of Hg(II) by IGO, IGO-COOH and Imino-IGO.

| | Mercury | | | |
|---|---|---|---|---|
| | concentration | ΔH° | ΔS° | −ΔG° |
| Adsorbent | (mg/L) | (kJ/mol) | (kJ/mol · k) | (kJ/mol) |
| IGO | 100.00 | 24.22 | 0.21 | 38.36 |
| IGO- | 100.00 | 66.22 | 0.29 | 20.20 |
| COOH | | | | |
| Imino- | 100.00 | 67.45 | 0.29 | 26.67 |
| COOH | | | | |

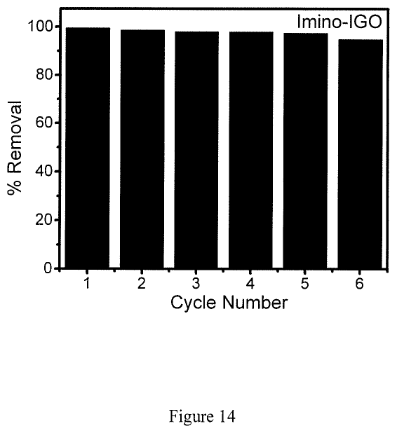

Regeneration and Recycling Studies. The desorption studies of Hg(II) from the IGO, IGO-COOH and Imino-IGO adsorbents show that the Hg(II) ions could be quantitatively desorbed with recovery above 99.0%.using 0.01 M EDTA or 1 M HCl. The results are given in Tables 12, 13, and 14. The regenerated adsorbent using HCl as desorbing agent is further treated with NaOH to restore the negative charge of carboxylic group of Imino-IGO then washed several times with deionized water. In order to determine the reuse ability of the composites, the successive adsorption-desorption process was carried out for six times at 300 ppm. FIG. 14 shows that after six adsorption-desorption cycle, in spite of slight decline, over 93.0% regeneration efficiency is still retained. These results confirmed that Imino-IGO has sufficient chemical stability over several adsorption-desorption cycles.

TABLE 12
Desorption studies of Hg(II) from IGO using 0.2-1M
HCl and 0.01M EDTA after the adsorption of 50 ppm.

| Desorbing agent | qₑ Adsorbed | qₑ Desorbed | |
|---|---|---|---|
| (mol/l) | (mg/g) | (mg/g) | % Desorption |
| 0.2M HCl | 21.2 | 16.5 | 77.9 |
| 0.4M HCl | 21.2 | 18.4 | 86.7 |
| 0.8M HCl | 21.2 | 21.2 | 100.0 |
| 1.0M HCl | 21.2 | 21.1 | 99.5 |
| 0.01M EDTA | 21.2 | 21.2 | 100.0 |

TABLE 13
Desorption studies of Hg(II) from IGO-COOH using
0.2-1M HCl after the adsorption of 300 ppm.

| Desorbing agent | qₑ Adsorbed | qₑ Desorbed | |
|---|---|---|---|
| (mol/l) | (mg/g) | (mg/g) | % Desorption |
| 0.2M HCl | 119.6 | 32.3 | 27.0 |
| 0.4M HCl | 119.6 | 72.0 | 60.2 |
| 0.8M HCl | 119.6 | 105.8 | 88.5 |
| 1.0M HCl | 119.6 | 119.2 | 99.7 |
| 0.01M EDTA | 119.6 | 119.6 | 100.0 |

TABLE 14
Desorption studies of Hg(II) from Imino-IGO using
0.2-1M HCl after the adsorption of 300 ppm.

| Desorbing agent | qₑ Adsorbed | qₑ Desorbed | |
|---|---|---|---|
| (mol/l) | (mg/g) | (mg/g) | % Desorption |
| 0.2M HCl | 197.2 | 103.3 | 52.4 |
| 0.4M HCl | 197.2 | 108.7 | 55.2 |
| 0.8M HCl | 197.2 | 120.2 | 60.9 |
| 1.0M HCl | 197.2 | 120.2 | 60.9 |
| 0.01M EDTA | 197.2 | 196.0 | 99.4 |

### Comparison of the Adsorption Capacities of Different Adsorbents Toward Hg(II)

Table 15 lists comparisons of the maximum adsorption capacities of IGO, IGO-COOH, and Imino-IGO adsorbents prepared in this study with various adsorbents previously used for the adsorption of Hg(II). The comparisons indicate that the chemically modified GO-based adsorbents IGO, IGO-COOH and Imino-IGO exhibit higher adsorption capacity than that of most of the other adsorbents reported in the literature, suggesting that these adsorbents are excellent candidates for commercial applications involving the effective removal of Hg(II) from aqueous solutions.

TABLE 15
Comparison of the adsorption capacities
of Hg(II) ions onto various adsorbents.

| | Adsorption |
|---|---|
| Adsorbents | capacity (mg/g) |
| 1-Acylthiosemicarbazide-modified activated carbon | 67.8 |
| Silica gel with alkynyl terminated monolayer | 174.3 |
| A novel thymine-functionalized MIL-101 | 51.7 |
| Magnetic Fe₃O₄@SiO₂ nanoparticles | 78.3 |
| Magnetic b-cyclodextrin bead and GO | 88.4 |
| Silica-3-chloropropyltriethoxysilane | 48.1 |
| Xanthate functionalized magnetic GO | 118.0 |
| GO/L-cysteine | 79.3 |
| Thiol-functionalized magnetite/GO | 289.9 |
| Graphene oxide/chitosan composite | 187.0 |
| Multi-walled carbon nanotubes | 89.0 |
| Improved Graphene Oxide (IGO) | 24.0 |
| Carboxylate IGO (IGO-COOH) | 122.0 |
| Imino-diacetic acid IGO (Imino-IGO) | 230.0 |

### Conclusions

For the removal of mercury from water or wastewater, chemically modified graphene oxide nanosheets IGO, IGO-COOH and Imino-IGO have been developed via chemical reactions with chloroacetic acid and ethylene diamine. The results of batch experiments show that the pH of the solution, contact time and initial concentration significantly affect the adsorption amount of Hg(II). The maximum sorption capacity is obtained at pH 5.0. The adsorption equilibrium follows the Langmuir isotherm and the calculated maximum adsorption capacities of 26.5, 123.2 and 235.8 mg/g agree well with the experimentally determined values of 24.0, 122.0 and 23.0 for the IGO, IGO-COOH and Imino-IGO nanosheets, respectively. The efficient adsorption of these materials and low cost of the reagents used in chemical modifications of graphene oxide provide economic feasibility for the commercial applications of these materials for the effective removal of mercury ions from aqueous solutions or wastewater.

### Example 3

### Laser Synthesis of Magnetite-Partially Reduced Graphene Oxide (Mag-PRGO) Nanocomposites for Efficient Arsenic Removal from Polluted Water

This example describes the synthesis of a solution-free, magnetite-partially reduced graphene oxide (Mag-PRGO) using the Laser Vaporization Controlled Condensation (LVCC) method which does not involve the use of any chemical reducing agents or solvents, and results in the formation of highly stable Mag-PRGO nanocomposites for efficient and recyclable arsenate removal from water.

### Experimental Section

2.1. Materials. All reagents were purchased from Sigma Aldrich and used without further purification. Iron powder, −325 mesh, 99.9%, GOLD LABEL, was purchased from Aldrich.
2.2. Synthesis of graphene oxide (GO). GO was prepared by the oxidation of graphite powder (<20 μm, Sigma Aldrich) according to the method of Hummers and Offeman (Hummers Jr, W. S.; Offeman, R. E., Journal of the American Chemical Society 1958, 80 (6), 1339-1339). The yellow-brown cake mixture was washed repeatedly with hot water and was dried overnight under vacuum.
2.3. Characterization. The adsorbents were characterized by X-ray diffraction using an X'Pert Philips Materials Research Diffractometer, FT-IR spectroscopy using the Nicolet-Nexus 670 FTIR Spectrometer, Diamond Attenuated Total Reflectance (DATR), X-ray Photoelectron Spectroscopy (XPS) using the Thermo Fisher ESCAlab 250, SEM using the Hitachi SU-70 FE-SEM, and TEM using the Jeol JEM-1230 microscope.
2.4. Extraction of As(V) Ions. The Adsorption of As(V) ions was studied in batch experiments at room temperature by adding 5 mg of Fe₃O₄ nanoparticles, PRGO, or Fe₃O₄/PRGO composite to a series of 20 mL glass vials containing 5 mL of As(V) ions solution at the desired initial concentration, pH, and agitation time. After adsorption the solution was centrifuged and the residual concentration of arsenate was measured by Inductively Coupled Plasma Optical Emission Spectroscopy (ICP-OES) where the samples were acidified with 2% HNO₃ prior for analysis. The adsorption capacity (qₑ) (mg/g) in all experiments was calculated as follows

$$\begin{matrix}Extraction \% = \frac{( {C}_{0} - {C}_{e} )}{{C}_{0}} \times 100 & ( 1 ) \\ {q}_{e} = \frac{( {C}_{0} - {C}_{e} ) V}{m} & ( 2 )\end{matrix}$$

where Cₒ and Cₑ are the initial and equilibrium concentration of As (V) ions (mg/L), respectively, m is the amount of adsorbent (g), and V is the volume of testing solution of As (V) ions (L).
2.5. Adsorption isotherms of As(V) on PRGO, Fe₃O₄ nanoparticles and Fe₃O₄/PRGO nanocomposite were investigated with initial concentrations of As(V) in the range of (0.1-500 mg/L) at room temperature (293 K), pH 4, and agitation time 2 h. Freundlich and Langmuir isotherms were utilized to fit the adsorption isotherms based on eqs (3), and (4), respectively.

$$\begin{matrix}ln {q}_{e} = ln {K}_{f} + \frac{1}{n} ln {C}_{e} & ( 3 ) \\ \frac{{C}_{e}}{{q}_{e}} = \frac{1}{b {Q}_{0}} + \frac{{C}_{e}}{{Q}_{0}} & ( 4 )\end{matrix}$$

where qₑ is the amount of As(V) adsorbed at equilibrium (mgg⁻¹), Cₑ is the equilibrium concentration of the As(V) ions (mg L⁻¹), constant b is related to the energy of adsorption (Lmg¹), and Qₒ is the Langmuir monolayer adsorption capacity (mgg⁻¹). K_{f} is the Freundlich constant (mgg⁻¹), n is the heterogeneity factor related to adsorption capacity and adsorption intensity.
2.6. Effect of competing anions and interferences. 100 (mgL⁻¹) of Cl⁻, HCO₃⁻, NO₃⁻, CH₂COO⁻, and HPO₄²⁻ anions were selected to study the effect of interfering anions on As(V) adsorption. Initial arsenate concentration was 100 mgL⁻¹ at pH 6, and agitation time 2 h.
2.7. Adsorption kinetics. The adsorption kinetic studies were investigated by using 50, and 300 mg/L as initial concentrations of As(V) at different time intervals (2, 5, 10, 15, 30, 45, 60, 90, 120, 150, 180, 240 min) at pH 4. After adsorption, the residual concentration of As(V) was determined by ICP-AES. The experimental data were analyzed based on pseudo-first and pseudo-second order kinetic models as shown in Eqs (5) and (6), respectively.

$$\begin{matrix}log ( {q}_{e} - {q}_{t} ) = log {q}_{e} - \frac{{K}_{1} t}{2.303} & ( 5 ) \\ \frac{t}{{q}_{t}} = \frac{1}{{K}_{2} {q}_{e}^{2}} + \frac{t}{{q}_{e}} & ( 6 )\end{matrix}$$

where qₑ (mgg⁻¹) and qₜ (mgg⁻¹) are the amounts of As(V) ions adsorbed at equilibrium and at time t (min), respectively. K₁ (min⁻¹) and K₂ (g mol⁻¹ min⁻¹) are the rate constants of pseudo-first and pseudo-second-order kinetic models, respectively.
2.8. Desorption Studies. Five consecutive adsorption-desorption cycles were conducted to determine the reusability of Fe₂O₃/PRGO nanocomposite. The adsorption experiments were performed in batch experiments. After adsorption, the magnetically separated adsorbent was gently washed with deionized water, then dispersed in 5 ml of desorbing agent (0.07 molL⁻¹ NaOH) and stirred for 4 h. The regenerated adsorbent was further washed to restore the pH between 4-6, then dried and used in removal of arsenate at pH 6.

### Results and Discussion

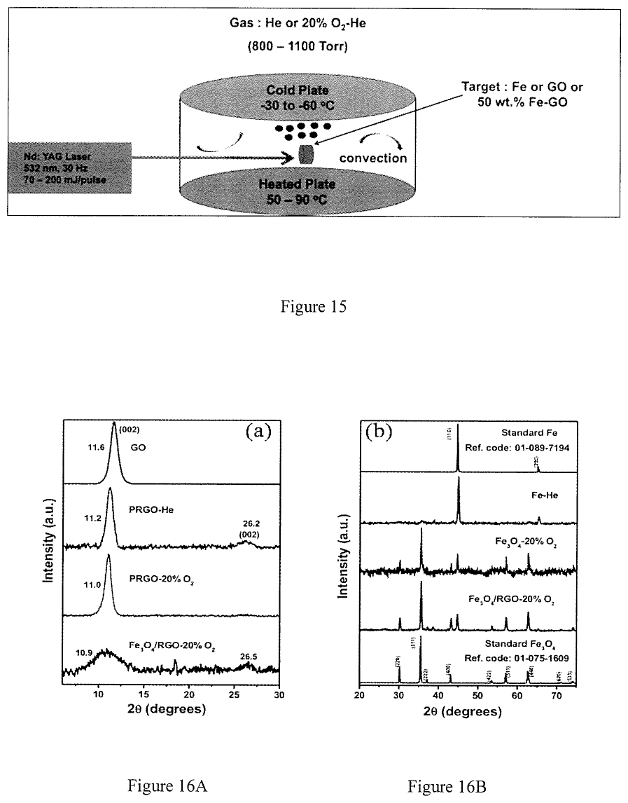

Laser synthesis of Mag-PRGO. For the LVCC synthesis of the Mag-PRGO adsorbents reported here, the method includes pulsed laser vaporization of the solid target GO nanosheets containing micron-sized metallic iron powder. The powder material is placed in an upward diffusion cloud chamber operating at well-defined temperatures and pressures and pressed into a cylindrical disk at e.g. 500 MPa using a hydraulic press, as shown schematically in FIG. 15. The chamber typically contains two horizontal, stainless steel plates, separated by a glass ring. The Fe-GO target material is positioned on the lower plate, and the chamber is filled with a pure helium carrier gas (99.99% pure) or a mixture containing a known composition of oxygen gas in helium (e.g. 20% O₂ in He). The Fe-GO target and the lower plate are maintained at a temperature (90° C.) higher than that of the upper plate (−140° C.). Temperatures are controlled by circulating fluids. The large temperature gradient between the bottom and top plates results in a steady convection current which is enhanced using high pressure conditions (800-1000 Torr). The laser vaporization process (using the second harmonic of a Nd:YAG laser, λ=532 nm, pulse width τ=7 ns, repetition rate=30 Hz, 40-60 mJ/pulse, Spectra Physics LAB-170-30) releases Fe atoms into the gas phase (about 10¹⁴ atoms per laser pulse) along with partially reduced graphene oxide (PRGO) nanosheets which act as a host for the nucleating Fe or Fe oxide nanoparticles (depending on whether or not O₂ is present in the carrier gas mixture) thus forming the Fe-PRGO or Fe₃O₄-PRGO composite nanosheets. The resulting composite nanosheets are carried by convection and deposited on the cold top plate of the chamber. No materials are found anywhere else in the chamber other than on the top plate, thus supporting the assumption that convection carries the sheets to the top plate where deposition occurs.
Materials' Characterization and Properties. FIG. 16(A) displays the XRD patterns of GO prepared using the Hummers' method, PRGO nanosheets prepared by LVCC from GO targets in He and in a 20% O₂—He mixture, and Fe₃O₄/PRGO nanocomposite prepared by LVCC of an Fe-GO target in a 20% O₂—He mixture. The PRGO sample prepared in He displays a peak at 2θ=11.2° indicating a d-spacing of the PRGO sheets of 7.9 Å as compared to 7.6 Å in the as prepared GO from the oxidation of graphite powder. The XRD pattern also displays a small and broad peak at 2θ=26.2° resulting from the restacking of the PRGO nanosheets. Similarly, the XRD pattern of the Fe₃O₄/PRGO sample prepared in a 20% O₂-He mixture shows a small and broad peak at 2θ=10.9 indicating a d-spacing of 8.1 Å between the PRGO nanosheets probably due to the incorporation and anchoring of the Fe₃O₄ nanoparticles within the sheets. This higher degree of reduction is facilitated by the presence of metal Fe which is assisting in the reduction of the GO nanosheets.

FIG. 16(B) displays the XRD patterns of the Fe and Fe₃O₄ nanoparticles prepared by LVCC from an Fe target in He and in a 20% O₂—He mixture, respectively and the Fe₃O₄/PRGO nanocomposite prepared from an Fe-GO target in a 20% O₂—He mixture. The Fe nanoparticles prepared in He show the (110) and (200) diffraction planes corresponding to metallic Fe in addition to very small peaks corresponding to Fe₃O₄ as a surface oxide layer formed after the exposure of the Fe nanoparticles to air following the LVCC process. The XRD pattern of Fe₃O₄ nanoparticles prepared in a 20% O₂—He mixture show major peaks corresponding to Fe₃O₄ and minor peaks corresponding to metallic Fe indicating that the main species are present as Fe₃O₄ with a small fraction of Fe nanoparticles. Similarly, the XRD pattern of the Fe₃O₄/PRGO sample confirms that Fe₃O₄ is the main oxide species present. Interestingly, more diffraction peaks of Fe₃O₄ are observed in the Fe₃O₄/PRGO sample in comparison with the Fe₃O₄ sample prepared in the absence of GO. This could suggest that the oxygen containing species liberated from GO during the LVCC process are being utilized for the oxidation of the Fe to Fe₃O₄ nanoparticles.

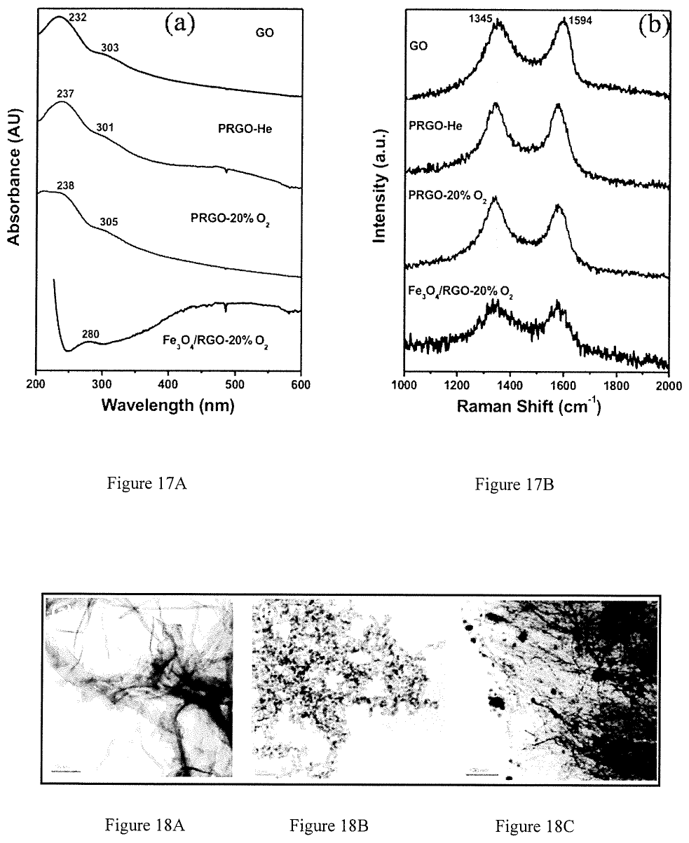

The UV-Vis spectra of the PRGO nanosheets and the Fe₂O₃/PRGO nanocomposites prepared by the LVCC method confirmed that the degree of reduction of GO was significantly more in the Fe₂O₃/PRGO nanocomposites than the PRGO sample prepared in the absence of Fe₂O₃ (FIG. 17A). The spectrum of GO showed two adsorption bands at 237 and 305 nm corresponding to the π→π* (C═C) and n→π* (C═O) transitions. For the Fe₃O₄/PRGO nanocomposite, the π→π* peak was red-shifted to 280 nm indicating a significant reduction of the graphene oxide nanosheets and supporting the assumption that the Fe₃O₄ nanoparticles are formed by the simultaneous oxidation of the Fe nanoparticles and reduction of GO, resulting in the formation of the Mag-PRGO nanocomposites.

Raman spectra were obtained for these samples (FIG. 17B). The spectrum for the exfoliated GO showed a broad blue-shifted G-band at (1594 cm⁻¹) along with the broad D-band at (1345 cm⁻¹) as compared to graphite. The blue shifting of the G-band of GO is attributed to the resonance of π electrons at a higher frequency by the presence of the isolated double bonds. Likewise, the red-shifted G and D bands for the PRGO samples prepared, respectively, in He and 20% O₂, and the Fe₃O₄/PRGO nanocomposite are located at ˜1577 and ˜1340 cm⁻¹, respectively. It is interesting to note that the G-band for the nanosheets corresponding to the laser treated samples is similar to that observed for graphite (1575 cm⁻¹). The G-band arises from the vibrations of sp²-hybridized carbons atoms while the D-band corresponds to structural disorder at defect sites. The intensity ratio of the D-band to the G-band was calculated for the samples and this was used to evaluate the quality of the graphitic structures because for highly ordered pyrolytic graphite, this ratio approaches zero. The I_{D}/I_{G} ratio for GO, PRGO prepared in He and 20% O₂, and the Fe₃O₄/PRGO nanocomposite are 0.98, 1.00, 1.15, and 1.00, respectively. The I_{D}/I_{G} ratio for PRGO nanosheets prepared in 20% O₂ is 1.15 denoting a higher presence of structural disorder and defects in comparison to the other samples.

SEM images for (a) Fe₃O₄ nanoparticles and (b) Fe₃O₄-PRGO nanocomposite after 2 hours of exposure to arsenate solution showed no significant changes in the morphology of the adsorbents after arsenate exposure. SEM mapping of the C, Fe, and As lines for the Fe₃O₄-PRGO nanocomposite after arsenate exposure did denote the presence and adsorption of arsenate on the nanocomposite.

TEM images for PRGO nanosheets, Fe₃O₄ nanoparticles, and Fe₃O₄-PRGO nanocomposite prepared in 20% O₂ via the LVCC method confirmed the presence of multiple stacked PRGO nanosheets (FIGS. 18A-C). The images showed that Fe₃O₄ nanoparticles exhibited web-like interconnections. The structural morphology of the nanoparticles indicated that they have a reasonable surface area. Further TEM images showed the presence of the Fe₃O₄ nanoparticles anchored on the surface of the reduced graphene oxide nanosheets. Agglomerated particles were present on the edges of the sheets where they were stabilized by the high surface energy.

The surface functional groups of GO, PRGO in 20% O₂, Fe₃O₄ in 20% O₂, Fe₃O₄/PRGO in 20% O₂ composite were investigated by FT-IR. The spectra revealed large broad adsorption peaks at 3328 and 1735 cm⁻¹ that related to O—H bond stretching and C═O stretching vibrations in carboxylic acid groups. In addition, characteristic bands at 1200, 1050, and 830 cm⁻¹ related to C—OH stretching symmetric, and a symmetric stretching vibration in epoxy groups, respectively, were seen. After laser irradiation in the presence of 20% O₂, the intensity of the peak at 1754 decreased, indicating that GO had been partially reduced. The FTIR spectra of pure magnetite in 20% O₂ showed peaks at 3328, 1616, 1307, 921 cm⁻¹ related to the (O—H, and Fe—O) stretching and bending vibrations. The FTIR spectra of Fe₃O₄/PRGO showed a peak at 3328 cm⁻¹ corresponding to O—H stretching vibration, while peaks at 1075 and 935 cm⁻¹ corresponded to (C—O—C, and O—H), and Fe—O vibrations. These results confirmed that a wide range of oxygen containing functional groups were located on the graphene oxide sheets after decoration with magnetite nanoparticles. A significant new peak was observed near 580 cm⁻¹, and was assigned to the stretching vibration of the Fe—O bond. This new peak indicated that the COOH groups of GO reacted with Fe and/or hydroxyl groups of magnetite nanoparticles, resulting in the formation of iron carboxylate. Thus, the magnetite nanoparticles were covalently bonded to the GO.

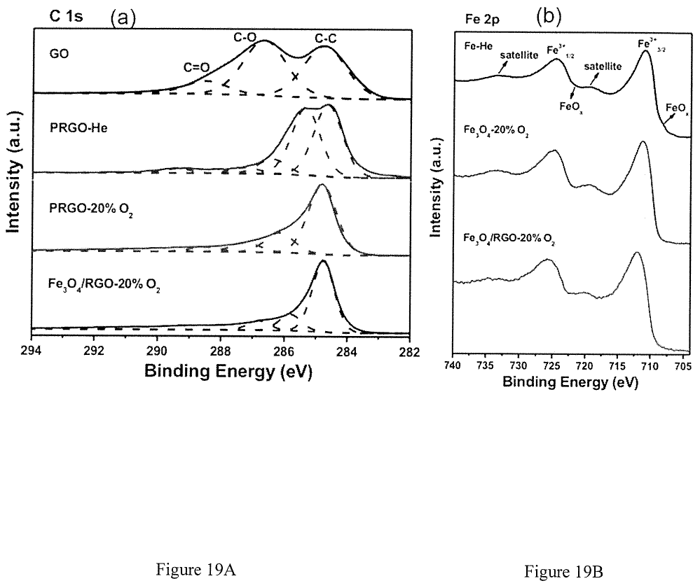

The XPS spectrum for GO showed an sp²-bonded C═C peak at 284.8 eV, and peaks corresponding to the C—O and C═O bonds were observed at 286.7 and 288.5 eV, respectively (FIGS. 19A and B). Typically, C1s peaks for the C—OH, C—O, C═O, HO—C═O groups are observed at 285.6, 286.7, 287.7, and 289 eV, respectively. After the GO sample was laser irradiated at 532 nm in the presence of high purity He gas, minimal reduction of the oxygenated functional groups was observed for the PRGO-He sample. This indicates that the determined atomic C/O ratio of 0.8 is the same for GO. The carbon and oxygen percentages were determined from the fitted deconvoluted peaks. For the PRGO-20% O₂ and Fe₃O₄/RGO-20% O₂ samples, the atomic C/O ratios were calculated to be 2.0 and 2.7, respectively. The XPS spectra shows significant reduction of the oxygenated groups for these two samples. The XPS spectrum for the Fe 2p electron for the Fe—He sample showed two peaks centered at 710.9 and 724.6 eV corresponding to Fe³⁺2p_{3/2} and Fe³⁺2p_{1/2}, respectively. The two peaks denote the presence of Fe₂O₃ on the surface of the Fe⁰ nanoparticles, as indicated by the signature satellite peaks at 719.5 and 733.4 eV. The spectrum also showed the presence of sub-oxide species of Fe by the shoulder peaks centered at 708.3 (2p_{3/2}) and 721.9 eV (2p_{1/2}). The spectrum for the Fe₃O₄-20% O₂ sample also showed the presence of Fe₂O₃ on the surface with evidence of the Fe 2p_{3/2} and Fe 2p_{1/2} peaks at 711.3 and 724.7 eV. The spectrum also showed the presence of the signature satellite peaks. Moreover, for the Fe₃O₄/RGO-20% O₂ sample, Fe³⁺2p_{3/2} and 2p_{1/2} peaks were observed at 712.0 and 725.7 eV, corresponding to the presence of Fe₃O₄. The spectrum shows a small reduction of the satellite with respect to the Fe—He and Fe₃O₄-20% O₂ samples, indicating the existence of Fe₃O₄.
Arsenic Adsorption Isotherms. The effect of pH is one of the most critical parameters controlling the arsenate As(V) adsorption process. In order to assess the effect of initial pH on arsenic removal efficiency, batch adsorption experiments were carried out using a 50 ppm arsenate solution at pH values ranging from 2-8. The results revealed that the percentage of arsenate removal increased from 7.0% to 45.4%, from 76.0% to 84.0%, and from 84.8%, 99.0 for PRGO, Fe₃O₄, Fe₃O₄/PRGO, respectively, with the increase in pH from 2 to 6, then slightly decreased with the increase in pH from 6.5 to 8. The maximum removal efficiency occurred in the pH range 4-6 (approximately 98.0% using the Fe₃O₄/PRGO composite). The dependence of As(V) adsorption on pH may be caused by (1) electrostatic attraction (2) the formation of complexes by ion exchange. It is known that the species of ions in the aqueous solution is mainly determined by the pH and dissociation constants. The dissociation constants of aqueous As(V) are pKa₁=2.1, pKa₂=6.7, pKa₃=11.2; consequently, As(V) is present as H₂AsO₄⁻, HAsO₄²⁻, and AsO₄³⁻. There are many carboxyl and hydroxyl groups on the surface of PRGO, Fe₃O₄, and Fe₃O₄/PRGO, so at low pH values, these groups are protonated and the surface of the adsorbents is positively charged, facilitating the removal of arsenate anions via electrostatic attraction, because the predominate species of arsenate are H₂AsO₄⁻, and HAsO₄²⁻. At pH values above 6, the amount of negatively charged arsenate species is increased, and deprotonation of hydroxyl groups on the surface of adsorbents also increases. Strong electrostatic repulsion between the negatively charged adsorbent and the anionic arsenate species is likely responsible for decreased removal efficiency above pH 6.

Because the leaching of iron can increase the toxicity of As(V), the stability of the F₃O₄/PRGO adsorbent under different pH conditions was investigated. The results showed that F₃O₄/PRGO adsorbent has higher stability than Fe₃O₄ adsorbent (1.51 mgL⁻¹ compared to 20.7 mgL⁻¹, respectively, (at pH 2). The amount of leached iron from Fe₃O₄/PRGO was less than 0.17 mgL⁻¹ at pH levels higher than 4.0, confirming the high stability of the Fe₃O₄ composite adsorbent. This low concentration of iron does not cause iron pollution or increase the toxicity of the As(V). Thus, a pH range of 4-6 was selected as optimal for As(V) adsorption.

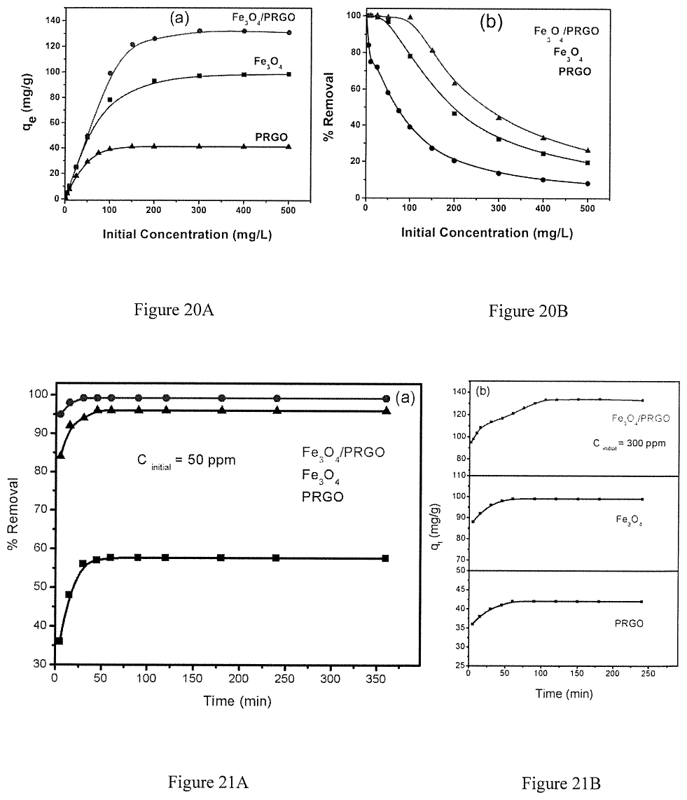

The adsorption equilibrium of arsenate As(V) was evaluated with initial concentrations in the range of 0.1-500 mg L⁻¹. FIGS. 20A and B show that the equilibrium adsorption capacities of the sorbents increased with increasing arsenate concentration. This is likely because the higher initial As(V) concentration is a driving force of the concentration gradient at the solid-liquid interface, causing an increase in the amount of adsorbed As(V). When the initial concentration of As(V) increased from 0.1 to 500 mg/L at 25° C., the amount of As(V)adsorbed at equilibrium (qₑ) increased from 0.1 to 41.1 mg/g, from 0.1 to 98.4 mg/g, and from 0.1 to 132.0 mg/g for PRGO, Fe₃O₄, Fe₃O₄/PRGO, respectively. The same conditions also applied for the removal of arsenate using Hummer GO, zerovalent Fe, PRGO in He, and improved graphene oxide. Table 16 shows the maximum adsorption capacities for the removal of arsenate using HGO, IGO, PRGO in O₂, PRGO in He, zerovalent Fe, Fe₃O₄, and Fe₃O₄/PRGO. A maximum adsorption capacity of 132.0 mg/g was observed for As(V) for Fe₃O₄/PRGO at 273 k and pH 4-6. This value is much higher than those previously reported for magnetic adsorbents and graphene based materials. Since Fe₃O₄/PRGO adsorbent showed 100% removal for low concentrations of arsenate (0.1-100 ppm), this material is feasible for use in the removal of arsenate from e.g. waste water.

TABLE 16
The maximum adsorption capacities of As (V) on Hummer GO,
Improved GO, PRGO (20% O₂), PRGO (He), Zerovalent Fe (He),
Fe₃O₄, Fe₃O₄/PRGO composite (wt).

| Adsorbent | q_{e(max) (mg/g)} |
|---|---|
| Hummer GO | 4.8 |
| Improved GO | 3.2 |
| PRGO (He) | 3.0 |
| PRGO (20% O₂) | 41.1 |
| Fe nanoparticles (He) | 45.0 |
| Fe₃O₄ nanoparticles | 98.4 |
| Fe₃O₄/PRGO (50 wt %) | 132.0 |

Two adsorption isotherm models are very useful to describe how the adsorbed molecules interact with the adsorbent. Freundlich and Langmuir models were used to describe the experimental data. The Langmuir model assumes homogeneous adsorption with monolayer adsorption coverage (i.e. all active sites are uniform). The Freundlich model assumes that adsorption is a multilayer heterogeneous adsorption. The equations of the isotherm models were presented above. The results showed that the Langmuir model fit better with the experimental data, indicating that the adsorption of As(V) by PRGO, Fe₃O₄, and Fe₃O₄/PRGO is a monolayer adsorption process. Moreover, the essential feature of the Langmuir isotherm can be defined as RL parameter given by the following equation.

$${R}_{L} = \frac{1}{1 + b {c}_{0}} \qquad ( 7 )$$

where b (Lmg⁻¹) is the Langmuir constant and Cₒ is the initial As(V) concentration (mg L⁻¹). The value of R_{L} indicates the shape of the isotherm to be either unfavorable (R_{L}>1), linear (R_{L}=1), favorable (0<R_{L}<1) or irreversible (R_{L}=0). R_{L} values between 0 and 1 indicate favorable adsorption for As(V) adsorption on PRGO, Fe₃O₄, and Fe₃O₄/PRGO.
Arsenic Adsorption Kinetics. The effect of contact time on As(V) adsorption on PRGO, Fe₃O₄, Fe₃O₄/PRGO at initial concentrations of 50 and 300 mg/L⁻¹ were determined at 25° C. The results are presented in FIGS. 21A and B and showed that for As(V) solutions with an initial concentration of 50 mg/L⁻, the contact time needed to reach equilibrium was between 30 to 45 min. For As(V) solutions with initial concentrations of 300 mg/L⁻¹, an equilibrium time of 100 min was required. The kinetics of the adsorption process indicated that the adsorbed amount of As(V) rapidly increased at the beginning because adsorption sites were void and As(V) easily interacted with these sites; more than 90% of the adsorption occurred within 10 min for PRGO, Fe₃O₄, and Fe₃O₄/PRGO, especially at As(V) concentrations lower than the maximum adsorbed. As(V) uptake remained almost constant after 45 min (PRGO), 60 min (Fe₃O₄), and 100 min (Fe₃O₄/PRGO composite). 100 min was considered to be the equilibrium time for the adsorption. However, all the experimental data were measured at 2 h to insure that full equilibrium was attained. At equilibrium, more than 99% of the As(V) had been removed from the aqueous solution by Fe₃O₄/PRGO when the initial As(V) concentration was 50 mg·L⁻¹.

Such finding reveals the benefits of using this low-cost adsorbent or so-called eco-adsorbent, for the treatment of wastewaters contaminated with arsenate.

Pseudo first order and pseudo-second order kinetic models were used to analyze the experimental kinetic data and showed that the pseudo-second-order kinetic model fits the experimental data well (correlation coefficient R²>0.999), whereas, poor agreement was seen with the pseudo first order model with the experimental data. The calculated maximum adsorption capacities of As(V) (q_{emax cal.}) were in good agreement with the experimental results. Thus, chemisorption through the sharing or exchange of electrons likely occurred between As(V) and the composite.

The effect of adsorbent dosage on removal of As(V) by Fe₃O₄/PRGO showed that an increase in adsorbent dose favors As(V) removal. When the sorbent dose increased from 1 to 5 g/L, the removal percentage of As(V) by Fe₃O₄/PRGO composite increased from 44.0% to 100.0%.
Effect of Competing Anions and Interference. Interfering anions, including Cl⁻, NO³⁻, CH₃COO⁻, HCO₃⁻, and HPO₄²⁻ exist widely in natural water, especially in ground water and industrial effluents. These anions might compete with arsenate anions for available surface binding sites and/or might change the surface charge of adsorbent. To study the selective binding of Fe₃O₄, and Fe₃O₄/PRGO adsorbents towards As(V), batch experiments were performed in the presence of 100 mg/L of Cl⁻, NO₃⁻, CH₃COO⁻, HCO₃⁻, and HPO₄²⁻ with an initial concentration of arsenate of 100 mg/L at pH 6. From FIGS. 22A and B It can be seen that there was no significant decrease in arsenate removal efficiency in the presence of Cl⁻, NO₃⁻, and CH₃COO⁻, which decreased from 99.0% to 94.0% for Fe₃O₄/PRGO, and from 78.0% to 74.0% for Fe₃O₄. The effect of HCO₃⁻ on arsenate adsorption was more marked (99.0% to 90.0% for Fe₃O₄/PRGO and 78.0% to 74.0% for Fe₃O₄). The results also revealed that the presence of HPO₄²⁻ significantly decreased the removal efficiency of arsenate on Fe₃O₄ (78.0% to 64%) and Fe₃O₄/PRGO (99.0% to 88.0%). This may be attributed to structural coincidence between As(V) and HPO₄²⁻ and HAsO₄²⁻. HPO₄²⁻ and HAsO₄²⁻ have similar atomic structures and chemical properties so they can form complexes via ligand substitution reaction on the surface of the adsorbent. Therefore, HPO₄²⁻ adsorbs strongly on the surface of iron oxides and has high tendency to form complexes with Fe(III) (the constant of binding affinity value for phosphate, which is seven times greater than As(V)). In addition, the ionic radii of HPO₄²⁻ (0.17 Å) is significantly smaller than that of As(V) (0.36 Å) because the length of its NO bond is shorter. Therefore, phosphate ions have a stronger charge density than As(V) ions. Consequently, the presence of PO₄³⁻ ions can interfere with the sorption of As(V) by Fe₃O₄ and Fe₃O₄/PRGO). However, since phosphate is also a contaminant in many water sources, these results show that the graphene-based materials described herein can be used for the removal of both arsenate and phosphate from polluted water.
Mechanism of As(V) adsorption on Mag-PRGO. The sorption of arsenate onto Fe₃O₄/PRGO was mainly influenced by two factors (1) the speciation of the arsenate, and (2) the charge of the sorbent surface. Under the optimum experimental conditions (pH 4-6) As(V) mainly exists as HAsO₄²⁻, and H₂AsO⁴⁻. Some of the functional groups of the composite were protonated and its surface thus became positively charged. FTIR spectra were obtained to further analyze the mechanism of As(V) adsorption on Fe₃O₄/PRGO. The FTIR spectra of Fe₃O₄/PRGO after As(V) adsorption show a new peak at 752 cm⁻¹ which was attributed to the stretching vibration of the Fe—O—As group. Therefore the mechanism of adsorption of As(V) on the surface of Fe₃O₄/PRGO involves the surface complexation between the deprotonated arsenate species (HAsO₄²⁻, H₂AsO₄) and protonated OH²⁺ groups on the surface of Fe₃O₄/PRGO composite. The OH groups on the surface were substituted by the deprotonated As(V) species through hydroxyl exchange mechanism. There is another suggestion that this band may be due to the coordination of the stretching As—O vibration with the Fe atom (As—O—Fe). This suggestion was also confirmed by the XPS spectra analysis for Fe₃O₄ and Fe₃O₄/PRGO composite before and after As(V) adsorption. The results showed the As 3d electron for the samples Fe₃O₄ and Fe₃O₄/PRGO after arsenate adsorption. Peaks were observed at 46.1 and 45.9 eV corresponding to the presence of arsenate species as As(V). FIG. 12(b) displays the XPS spectra for the O 1s electron for the Fe₃O₄-20% O₂ and Fe₃O₄/RGO-20% O₂ samples before and after arsenate adsorption. The XPS spectra for Fe₃O₄ and Fe₃O₄+As (V) samples show fitted peaks centered at 530.4, 531.8, and 533.4 eV corresponding to O₂— (Fe—O), OH— (Fe—OH), and H₂O, respectively denoting the presence of Fe oxide (Fe₂O₃ and Fe₃O₄) and FeOOH species. For the Fe₃O₄ sample after arsenate adsorption, a fitted peak was observed at 529.3 eV indicating the presence of As—O bonding and confirming the presence of arsenate ions on the surface of the adsorbent. Moreover, the XPS spectra for the Fe₃O₄/PRGO adsorbents before and after arsenate adsorption also showed the presence of the Fe—O, Fe—OH, and H₂O groups denoted by the occurrence of the fitted peaks at 530.5, 531.8, and 534.5 eV, respectively. For the Fe₃O₄/RGO sample after arsenate adsorption, a peak is observed at 529.9 eV, corresponding to the presence of As—O.

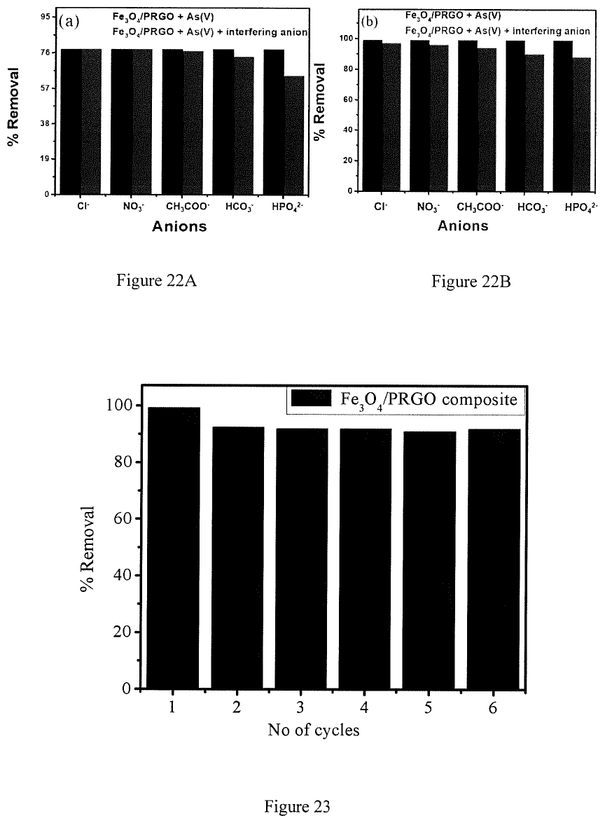

For the Fe₃O₄/RGO-20% O₂ sample, a fitted peak was observed at 531.0 eV corresponding to the existence of the Fe—O—C bond and thus indicating chemical attachments between the Fe₃O₄ nanoparticles and the PRGO nanosheets. This peak was also observed for the adsorbent after arsenate adsorption indicating the stability of the hybrid nanocomposite.
Application of Mag-PRGO for the removal of As(V) from Polluted Water. To test the analytical applicability of Fe₃O₄/PRGO composite for arsenate removal from real sample, natural water samples-were collected from James River, Richmond, Va., USA. The water samples were spiked with different amounts of As(V) and stirred well with Fe₃O₄/PRGO adsorbent. Desorption of As(V) from the Fe₃O₄/PRGO adsorbent was done using 5 mL 0.07 M NaOH. Results of the practical application for real samples are represented in Table 4.The results showed that the Fe₃O₄/PRGO composite could be efficiently used as a solid phase extraction material for the preconcentration and removal of As(V) from real samples. Also, this effective recovery of As(V) from spiked natural water samples strongly confirms the applicability of Fe₃O₄/PRGO composite in arsenate removal from wastewater without pretreatment.
Regeneration and Recycling. The Fe₃O₄/PRGO adsorbent after the adsorption of As(V) could be quantitatively desorbed by stirring with 5 mL of 0.07 M NaOH at 273 K. The recyclability of Fe₃O₄/PRGO for As(V) removal was studied by repeating the adsorption/desorption process for five times as shown in FIG. 23. It is clear that the adsorption efficiency of Fe₃O₄/PRGO for arsenate has no significant loss after 5 successive cycles (99.2-92.0). In addition, Fe₃O₄/PRGO still have magnetism and and can be easily separated by magnet. These results confirmed that Fe₃O₄/PRGO composite have sufficient chemical stability over several adsorption-desorption cycles.

Table 18 lists the comparisons of maximum adsorption capacity of Fe₃O₄/PRGO adsorbent prepared in this study with various adsorbents previously used for the adsorption of As(V). It can be seen that Fe₃O₄/PRGO adsorbent exhibit higher adsorption capacity than that of the most other adsorbents reported in the literature, suggesting that these adsorbents may be effective for As(V) removal from aqueous solution.

TABLE 18
Comparison of the adsorption capacities
of As(V) ions onto various adsorbents.

| | Adsorption |
|---|---|
| Adsorbents | capacities (mg/g) |
| Magnetite-Reduced Graphene Oxide Composites | 5.8 |
| Modified hydrous ferric oxide nanoparticles | 355.0 |
| magnetite/non-oxidative graphene composites | 3.7 |
| nanoscale zero valent iron-reduced graphite oxide | 29.0 |
| modified composites | |
| Layered Double Hydroxide Intercalated with | 56.0 |
| MoS₄²⁻ | |
| 2D-Fe₃O₄Nanosheets | 18.5 |
| Fe₃O₄@SiO₂@TiO₂nanosorbents | 10.0 |
| CoFe₂O₄@MIL-100(Fe) hybrid magnetic | 114.8 |
| nanoparticles | |
| magnetic thin-film MnO₂nanosheetcoated | 120.5 |
| flowerlike Fe₃O₄nanocomposites | |
| β-FeOOHNanorods/Carbon Foam-Based | 172.9 |
| Hierarchically Porous Monolith | |
| β-cyclodextrin functionalized graphene oxide | 100.2 |
| magnetic gelatin-modified biochar | 45.8 |
| Europium doped magnetic graphene oxide- | 289.0 |
| MWCNT nanohybrid | |
| magnetic nanoparticle-supported layered double | 83.0 |
| hydroxide nanocomposites | |
| Fe₃O₄/PRGO composite | 132.0 |

### Conclusions

A method of synthesizing Magnetite/Partially Reduced Graphene Oxide (Fe₃O₄/PRGO) using Laser Vaporization Controlled Condensation (LVCC) has been developed. The Fe₃O₄/PRGO is useful, e.g. for As(V) removal from contaminated water. The Fe₃O₄/PRGO adsorbent exhibits high selectivity, high adsorption capacity, a wide pH range 4-6 of activity, and a rapid adsorption rate for As(V) at room temperature, which is then easily separated from the surrounding milieu by application of an external magnetic field. The high removal efficiency (>99.0%) (at initial concentrations 0.1-100 mg/L) is superior to those of the previously reported adsorbents. The rate of adsorption is rapid, with about 90% removal within 10 min and maximum adsorption capacity 132.0 mg/g. Additionally, the results revealed that the Fe₃O₄/PRGO composite has the ability to regenerate and be reused for several successive cycles without losing efficiency and stability. In addition, As(V) can be recovered from the Fe₃O₄/PRGO adsorbent using 0.07 M NaOH. After five adsorption-desorption cycles, the reloading efficiency maintained above 95% with no significant loss in magnetic properties. On the basis of the data of the present study, Fe₃O₄/PRGO nanocomposite is an efficient, and eco-friendly adsorbent for As(V) removal from wastewater.

### Example 4

### Chemically Modified Graphene-Based Adsorbents Containing Iron for the Removal of Nitrate and Phosphate Ions from Wastewater and the Effluents of Sewage Treatments

The IT-PRGO and iron-based PRGO materials developed as described e.g. in the Examples above, are be used for the removal of nitrogen and phosphorus compounds. Ferrous ions generated from the iron-based PRGO materials combine with phosphate to produce ferrous phosphate materials that are adsorbed onto the iron-based PRGO. Phosphorous is thus removed from water and wastewater.

The newly developed IT-PRGO and the iron-based PRGO adsorbents exhibit remarkably high efficiency for the removal of nitrogen and phosphorous compounds from, e.g. the effluents of sewage treatment plants.

While the invention has been described in terms of its several exemplary embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

We claim:

1. A nanocomposite, 2-Imino-4-Thiobiuret Partially Reduced Graphene Oxide (IT-PRGO).

2. A method of making 2-Imino-4-Thiobiuret Partially Reduced Graphene Oxide (IT-PRGO), comprising
activating carboxylic groups of graphene oxide (GO),
combining, in the presence of a catalyst, GO having activated carboxylic groups and amidinothiourea, wherein the step of combining is performed under conditions sufficient to cause a nucleophilic substitution reaction between the activated carboxylic groups of the GO and the amidinothiourea, and
recovering the IT-PRGO.

3. The method of claim 2, further comprising a step of increasing the COOH-group content of the GO prior to the step of activating.

4. The method of claim 3, wherein the step of increasing is performed by reacting the GO with Cl—CH₂COOH under basic conditions.

5. The method of claim 2, wherein the step of activating is performed by reacting the GO with SOCL₂ to form acyl-chloride GO.

6. The method of claim 2, wherein the catalyst is tetra butyl ammonium bromide.

7. A method of removing heavy metal ions from contaminated water, comprising contacting the contaminated water with IT-PRGO for a period of time and under conditions sufficient to permit adsorption of the heavy metal ions by the IT-PRGO.

8. The method of claim 7, wherein the heavy metal ions are mercury (Hg) ions, lead (Pb) ions, cadmium (Cd) ions, chromium (Cr) ions, zinc (Zn) ions, Arsenic (As) ions, nickel (Ni) ions or copper (Cu) ions.

9. The method of claim 7, wherein the conditions sufficient to permit adsorption of the heavy metal ions by the IT-PRGO include performing the step of contacting at a pH of 5.0-5.5.

10. The method of claim 7, further comprising the steps of desorbing the heavy metal ions from the IT-PRGO and repeating the step of contacting, wherein the steps of desorbing and repeating are performed a plurality of times.

11. A method of removing phosphate ions and/or nitrate ions from contaminated water, comprising contacting the contaminated water with IT-PRGO for a period of time and under conditions sufficient to permit adsorption of the phosphate ions and/or the nitrate ions by the IT-PRGO.

12. The method of claim 11, further comprising the steps of desorbing the phosphate ions and/or the nitrate ions from the IP-PRGO and repeating the step of contacting, wherein the steps of desorbing and repeating are performed a plurality of times.

13. A method of removing mercury ions from contaminated water, comprising contacting the contaminated water with acetic acid functionalized improved graphene oxide (IGO-COOH) or with imino-diacetic acid functionalized improved graphene oxide (Imino-IGO) for a period of time and under conditions sufficient to permit adsorption of the mercury ions by the IGO-COOH or the Imino-IGO.

14. The method of claim 13, wherein the conditions sufficient to permit adsorption of the mercury ions include performing the step of contacting at a pH of 5.0-5.5.

15. The method of claim 13, further comprising the steps of desorbing the mercury ions from the IGO-COON or the Imino-IGO and repeating the step of contacting, wherein the steps of desorbing and repeating are performed a plurality of times.

16. A nanocomposite, Fe₃O₄-PRGO, comprising partially reduced graphene oxide (PRGO) and a plurality of Fe₃O₄ functional groups immobilized on the PRGO.

17. A method of making partially reduced graphene oxide (PRGO) comprising a plurality of Fe₃O₄ functional groups (Fe₃O₄/PRGO), comprising
combining dry, solventless PRGO and dry, solventless Fe₃O₄ nanoparticles, and
exposing the dry, solventless PRGO and dry, solventless Fe₃O₄ nanoparticles to a series of laser pulses sufficient to vaporize and ionize the Fe₃O₄ nanoparticles, wherein the step of exposing is performed under an O₂—He mixture.

18. The method of claim 17, wherein the O₂—He mixture is a 20% O₂ in He mixture.

19. The method of claim 17, wherein the step of exposing is performed at 800-1000 Torr of pressure.

20. The method of claim 17, wherein the series of laser pulses are preformed using λ=400-800 nm pulses, a pulse width of τ=5-20 ns, a repetition rate of 10-100 Hz, and an energy of about 30-100 mJ/pulse.

21. The method of claim 20, wherein the series of laser pulses are preformed using λ=532 nm pulses, a pulse width of τ=7 ns, a repetition rate of 30 Hz, and an energy of 40-60 mJ/pulse.

22. The method of claim 17, wherein each laser pulse releases at least 10¹⁴ Fe ions into the gas phase.

23. A method of removing phosphate ions and/or nitrate ions from contaminated water, comprising contacting the contaminated water with Fe₃O₄/PRGO for a period of time and under conditions sufficient to permit adsorption of the phosphate ions and/or the nitrate ions by the Fe₃O₄/PRGO.

24. The method of claim 23, further comprising a step of magnetically removing the Fe₃O₄/PRGO from the contaminated water after the period of time.
